(19) United States
(12) Patent Application Publication
(10) Pub. No.: US 2006/0092195 A1
(43) Pub. Date: May 4, 2006

(54) Printing support system, printer and printing support program, and printing support method

(75) Inventor: Shinji Miwa, Hokuto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/258,542

(22) Filed: Oct. 25, 2005

(30) Foreign Application Priority Data
Oct. 26, 2004 (JP) 2004-310431
Aug. 3, 2005 (JP) 2005-225581

(51) Int. Cl. B41J 29/38

(52) U.S. Cl. 347/5

(57) ABSTRACT

A printing support system that supports using a recording agent to print includes: a recording agent information memory unit that memorizes recording agent information of the characteristics of a plurality of the recording agents; a characteristics input unit that inputs the characteristics of the recording agent; an adaptation judgment unit that judges, based on the recording agent information in the recording agent information memory unit, among the plurality of recording agents, one that adapts to the characteristics inputted at the characteristics input unit; and a recording agent presentation unit that presents a recording agent that is judged at the adaptation judgment unit.

### RELATED APPLICATIONS

This application claims priority to Japanese Patent Application Nos. 2004-310431 filed Oct. 26, 2004 and 2005-225581 filed Aug. 3, 2005 which are hereby expressly incorporated by reference herein in their entirety.

### BACKGROUND

1. Technical Field

The invention relates to a system, a printer and program, and a method that support printing with a recording agent, in particular, a printing support system, a printer and printing support program and a printing support method with which even a user who does not have technical knowledge of the recording agent can preferably realize proper characteristics in accordance with a usage environment where a printed matter is used.

2. Related Art

Several techniques for improving the color reproducibility in a printed matter are known such as, for instance, an ink set described in JP-A No. 2004-155827, an ink set described in JP-A No. 2000-351928 and an ink composition described in WO99/05230.

In the techniques disclosed in the above patent literatures, an ink such as red, orange, green or violet is used in addition to the four color inks of CMYK that are the principal colors, to expand a color gamut that a printer can represent. Since a color gamut that the printer can represent is expanded, a color gamut necessary for printing can be readily realized and the color reproducibility can be improved.

On the other hand, another technique is known where a plurality of ink cartridges is exchanged to print as disclosed in, for instance, an ink jet type recording device described in JP-A No. 2001-130019, a printing system described in JP-A No. 2001-21962, and a printer described in JP-A No. 2004-9527.

The invention described in JP-A No. 2001-130019 relates to an ink jet type printer where ink drops are discharged from a plurality of nozzle openings on a head surface of an ink jet type recording head to bombard a printing medium. As such, printing information is recorded thereon. To accomplish this, a row of nozzles having a plurality of nozzle openings on a head surface of a recording head are formed and the row of nozzles is divided into a plurality of nozzle groups in accordance with a plurality of recording blocks. Ink cartridges arranged in colors corresponding to the respective recording blocks are installed on a cartridge holder, the ink cartridges being imparted with color information and provided with an ink cartridge detector for detecting the color information thereof.

In the invention described in JP-A No. 2001-21962, as an ink cartridge, either a color printing cartridge having three color inks of CMY or a large capacity cartridge exclusive for black-and-white printing, which has a size and structure which is the same as that of the color printing cartridge but is provided only with, in place of the three color inks of CMY, a K ink can be selectively installed. Each of the cartridges has an EEPROM in which a color code showing an ink configuration (CMY or K alone) of the cartridge is recorded. A printer driver acquires the color code stored in the EEPROM of the cartridge at the beginning of printing. When the color code exhibits the CMY inks, the printer is controlled as a color printer, and when the color code exhibits only the K ink, the printer is controlled as a large capacity printer exclusive to black-and-white printing.

In the invention described in JP-A No. 2004-9527, when, among a plurality of applicable inks including at least one standard ink and a first light-colored ink that is substantially the same hue with any one of the standard inks but lower in concentration, the first light-colored ink is changed to a black ink, a separate kind of printing which is different in the characteristics of the printing performance can be performed.

On the other hand, a technique also exists for improving the color development properties and the glossiness of the printed matter as disclosed in, for instance, a manufacturing method of ink jet recorded matter described in JP-A No. 2003-266932.

In the invention described in JP-A No. 2003-266932, a clear ink composition that includes water, a cationic resin and polymer fine particles but does not include a coloring agent, and a color ink composition that includes a coloring agent are, respectively, adhered to a printing medium to print.

Printed matters such as posters and so on are now used in a variety of environments. Accordingly, such printed matters are desirably imparted with characteristics appropriate for their particular usage environments. For instance, printed matters posted under illumination are preferably imparted with color development properties, and printed matters posted outdoors are preferably imparted with water resistance and friction resistance. In recent years, like the invention described in JP-A No. 2003-266932, there are recording agents (colored ink or colorless ink) that can impart color development properties and glossiness to printed matters. Accordingly, when an appropriate recording agent can be selected at the time of printing, the appropriate characteristics corresponding to the known usage environments can be imparted to printed matters.

This is similarly assumed, without being restricted to the case where recording agents having characteristics that are impartable to the printed matters being selected, when the characteristics representable on printed matters, the characteristics that can correspond to kinds of printing media or performances of printers, or recording agents having other characteristics are selected as well. This is because all are identical in that appropriate characteristics are realized in accordance with the usage environment of the printed matters.

However, the inventions described in JP-A Nos. 2004-155827 and 2000-351928 and WO99/05230 only expand a color gamut by using additional inks, and the inventions described in JP-A Nos. 2001-130019, 2001-21962 and 2004-9527 only exchange the ink cartridge when judged desirable by the user. In all of these, when the user does not have technical knowledge of the recording agents, an appropriate recording agent cannot be selected; that is, it is difficult to realize the appropriate characteristics in accordance with the usage environments of the printed matters.

Furthermore, in the inventions described in JP-A Nos. 2004-155827 and 2000-351928 and WO99/05230, in order to correspond to many usage environments, it is necessary to prepare a large number of inks. In this case, a printer has to be configured so as to be capable of accommodating the installation of a large number of ink cartridges; however, it is impractical to configure the printer in such a way because a structure thereof becomes complicated.

### SUMMARY

The invention was made paying attention to the unsolved problems associated with such existing techniques and firstly intends to provide a printing support system, a printer and printing support program and a printing support method with which even a user who does not have technical knowledge of the recording agent can preferably realize proper characteristics in accordance with an environment where a printed matter is used. The invention secondly intends to provide a printing support system, a printer and printing support program and a printing support method with which a structure of the printer is not complicated.

Mode 1: In order to achieve the advantage of the invention, a printing support system according to mode 1 is a printing support system that supports use of a recording agent to print.

The printing support system includes:

a recording agent information memory unit that memorizes recording agent information of the characteristics of a plurality of the recording agents;

a characteristics input unit that inputs the characteristics of the recording agent;

an adaptation judgment unit that judges, based on the recording agent information in the recording agent information memory unit, among the plurality of recording agents, one that adapts (corresponds) to the characteristics inputted at the characteristics input unit; and

a recording agent presentation unit that presents a recording agent that is judged at the adaptation judgment unit.

When the printing support system is so configured and the characteristics of the recording agent are input at the characteristics input unit, the adaptation judgment unit judges, based on the recording agent information of the recording agent information memory unit, among the plurality of recording agents, one that adapts to the inputted characteristics, and the recording agent presentation unit presents a judged recording agent.

Thereby, when the presented recording agent is used to print, an advantage can be obtained that the most appropriate characteristics corresponding to a usage environment of the printed matters can be realized easily. Furthermore, since the only necessity is to replace the recording agent, there is no need of disposing many recording agent holding units in the printer. Accordingly, there is an advantage in that a structure of the printer does not become complicated.

The presentation here includes, other than to display identification information of the recording agents with a display device, to print the identification information of the recording agents with a printer and so on, to audio output identification information of the recording agents with an audio output unit, and, when communicating with a user terminal through a network, to send the identification information of the recording agents to the user terminal. Accordingly, the presentation includes displaying, printing, audio outputting and transmission. In what follows, this is the same as well in a printing support system according to mode 2, printers according to modes 16 and 17, printing support programs of modes 22 and 23 and printing support methods of modes 37 and 38.

Furthermore, the recording agent, as far as it has the predetermined characteristics, may be any one. The predetermined characteristics include, for instance, the characteristics that can impart to or be represented on the printed matters or the characteristics that can correspond to the kinds of the printing media and performances of the printers. Still furthermore, other than colored recording agents, colorless recording agents are also included. As the colorless recording agent, for instance, transparent inks correspond thereto. In what follows, this is the same as well in printing support systems according to modes 2, 9 and 10, printers according to modes 16 through 19, printing support programs according to modes 22, 23, 30 and 31 and printing support methods according to modes 37, 38, 45 and 46.

The recording agent information may be constituted of a recording set made of a plurality of recording agents as a unit or of a recording agent as a unit. It goes without saying that recording agent information constituted of the respective units may be present together. In what follows, this is the same as well in printing support systems according to modes 2, 9 and 10, printers according to modes 16 through 19, printing support programs according to modes 22, 23, 30 and 31 and printing support methods according to modes 37, 38, 45 and 46.

The recording agent information memory unit memorizes (i.e., stores) the recording agent information by all methods and at any times. That is, it may memorize the recording agent information in advance, and, without memorizing the recording agent information in advance, may memorize the recording agent information by external input when the system is in operation. In what follows, this it the same as well in printing support systems according to modes 2, 9 and 10, and printers according to modes 16 through 19.

Furthermore, the system may be realized as a single unit, terminal and other device, alternatively as a network system in which a plurality of units, terminals and other devices are communicatably connected. In the latter case, the respective constituent elements, as far as these are communicatably connected, may belong to any one of the plurality of devices. In what follows, this is the same in printing support systems according to modes 2, 9 and 10.

Mode 2: Furthermore, a printing support system according to mode 2 is a printing support system that supports using a recording agent to print.

The printing support system includes:

a recording agent information memory unit that memorizes recording agent information of the characteristics of a plurality of the recording agents;

a usage environment input unit for inputting a usage environment of a printed matter;

a characteristics judgment unit that judges, based on the usage environment inputted at the usage environment input unit, the characteristics necessary for the recording agent;

an adaptation judgment unit that judges, based on the recording agent information in the recording agent information memory unit, among the plurality of recording agents, one that adapts to the characteristics-judged at the characteristics judgment unit; and

a recording agent presentation unit that presents a recording agent judged at the adaptation judgment unit.

When the printing support system is so configured and the usage environment of the printed matters is input at the usage environment input unit, the characteristics judgment unit judges, based on the inputted usage environment, the characteristics necessary for the recording agent. Then, the adaptation judgment unit judges, based on the recording agent information of the recording agent information memory unit, among the plurality of recording agents, one that adapts to the judged characteristics, and a judged recording agent is presented.

Thereby, when the presented recording agent is used to print, an advantage can be obtained that the most appropriate characteristics corresponding to a usage environment of the printed matters can be realized easily. Furthermore, since the only necessity is to replace the recording agent, there is no need of disposing many recording agent holding units in the printer. Accordingly, there is an advantage in that a structure of the printer does not become complicated.

Mode 3: A printing support system according to mode 3, in the printing support system according to mode 2, further includes:

a recording agent requirement characteristics information memory unit that memorizes recording agent requirement characteristics information of the characteristics necessary for the recording agent for each of usage environments of the printed matters;

wherein the characteristics judgment unit is constituted so as to judge the characteristics necessary for the recording agent based on recording agent requirement characteristics information of the recording agent requirement characteristics information memory unit.

When the printing support system is so configured, the characteristics judgment unit can judge the characteristics necessary for the recording agent based on recording agent requirement characteristics information of the recording agent requirement characteristics information memory unit.

Thereby, there is an advantage in that the characteristics necessary for the usage environment of the printed matters can be relatively assuredly judged.

Mode 4: A printing support system according to mode 4, in the printing support system according to any one of modes 1 through 3, further includes:

a printing color gamut calculation unit that calculates a color gamut necessary for printing based on printing data;

wherein the adaptation judgment unit calculates an evaluation value based on a color gamut that the recording agent can represent and a color gamut calculated at the printing color gamut calculation unit; and

the recording agent presentation unit is constituted so as to present the recording agents or combinations thereof based on the evaluation values calculated at the adaptation judgment unit.

When the printing support system is so configured, the printing color gamut calculation unit, based on the printing data, can calculate the color gamut necessary for the printing. The adaptation judgment unit, based on the color gamut that the recording agent can represent and the calculated color gamut, calculates an evaluation value, and the recording agent presentation unit presents the recording agents or combinations thereof based on the calculated evaluation value.

Thereby, the recording agents or combinations thereof adapted to the color gamut necessary for the printing can be presented. Accordingly, an advantage can be obtained in that the color gamut necessary for the printing becomes easier to realize.

Mode 5: A printing support system according to a mode 5, in the printing support system according to any one of modes 1 through 4, further includes:

a printing color gamut calculation unit that calculates, based on the printing data, a color gamut necessary for printing;

wherein the adaptation judgment unit calculates, based on the recording agent information of the recording agent information memory unit, a degree at which a color gamut that the recording agent can represent covers the color gamut calculated at the printing color gamut calculation unit, and, from a degree that covers the calculated color gamut and a degree that adapts to the inputted or judged characteristics, an evaluation value; and

the recording agent presentation unit presents a recording agent or a combination thereof having the largest evaluation value calculated at the adaptation judgment unit.

when the printing support unit is so configured, the printing color gamut calculation unit can calculate a color gamut necessary for printing based on the printing data. Next, the adaptation judgment unit calculates, based on the recording agent information of the recording agent information memory unit, a degree at which a color gamut that the recording agent can represent covers the calculated color gamut, and, from a degree covering the calculated color gamut and a degree adapting to the inputted or judged characteristics, an evaluation value. The recording agent presentation unit presents the recording agent or the combination thereof having the largest calculated evaluation value.

Thereby, recording agents or combinations thereof adapted to the color gamut necessary for the printing can be presented; accordingly, an advantage can be obtained that the color gamut necessary for the printing becomes easier to realize.

Here, as the recording agent information, for instance, the recording agent information relating to the color gamut that the recording agent can represent, or the recording agent information relating to the characteristics other than the color gamut of the recording agent can be used. In what follows, this is the same also in printing support systems according to modes 7 and 12, printing support programs according to modes 26, 28 and 33, and printing support methods according to modes 41, 43 and 48.

Furthermore, the adaptation judgment unit and the recording agent presentation unit, when the recording agent is presented based on the recording agent information of the characteristics other than the color gamut of the recording agent, for instance, calculate a color gamut that the recording agent can represent for each of the recording agents based on the recording agent information, and can present the recording agents based on the calculation result. In what follows, this is the same in a printing support system according to mode 7.

Mode 6: A printing support system according to mode 6, in the printing support system according to the mode 5, further includes:

a recording agent color gamut calculation unit that calculates, based on the recording agent information of the recording agent information memory unit, from a color, gamut that each of a plurality of the recording agents can represent, a color gamut that a mixed color of the recording agents can represent;

wherein the adaptation judgment unit calculates, based on results calculated at the recording agent color gamut calculation unit, a degree at which the color gamut that the recording agent can represent covers a color gamut calculated at the printing color gamut calculation unit, and, from a degree of covering the calculated color gamut and a degree of adapting to the inputted or judged characteristics, an evaluation value; and

the recording agent presentation unit presents a recording agent or a combination thereof having the largest evaluation value calculated at the adaptation judgment unit.

When the printing support system is so configured, the recording agent color gamut calculation unit calculates, based on the recording agent information of the recording agent information memory unit, from a color gamut that each of the plurality of recording agents can represent, a color gamut that a mixed color of the recording agents can represent. Next, the adaptation judgment unit calculates, based on results calculated at the recording agent color gamut calculation unit, a degree at which a color gamut that the recording agent can represent covers the calculated color gamut, and, from a degree that covers the calculated color gamut and a degree adapting to the inputted or judged characteristics, an evaluation value. Then, the recording agent presentation unit presents the recording agent or the combination thereof having the largest evaluation value.

Thereby, the color gamut when a plurality of recording agents is combined can be calculated. Accordingly, a plurality of recording agents or combinations thereof adapted to the color gamut necessary for the printing can be presented. As a result, an advantage can be obtained that the color gamut necessary for the printing can be more easily realized.

Mode 7: A printing support system according to mode 7, in the printing support system according to any one of modes 1 through 4, further includes:

a printing color gamut calculation unit that calculates, based on the printing data, a color gamut necessary for the printing;

wherein the adaptation judgment unit calculates, based on the recording agent information of the recording agent information memory unit, a degree at which a color gamut that the recording agent can represent covers the color gamut calculated at the printing color gamut calculation unit, and from a degree that cover the calculated color gamut and a degree adapting to the inputted or judged characteristics, an evaluation value; and

the recording agent presentation unit presents the recording agents or the combinations thereof in descending order of the evaluation values calculated at the adaptation judgment unit.

When the printing support system is so configured, the printing color gamut calculation unit can calculate, based on the printing data, a color gamut necessary for the printing. Then, the adaptation judgment unit calculates, based on the recording agent information of the recording agent information memory unit, a degree at which a color gamut that the recording agent can represent covers the calculated color gamut, and, from a degree that covers the calculated color gamut and a degree adapted to the inputted or judged characteristics, an evaluation value. The recording agent presentation unit presents the recording agents or the combinations thereof in descending order of the calculated evaluation values.

Thereby, the recording agents or combinations thereof adapted to the color gamut necessary for the printing can be preferentially presented. Accordingly, an advantage can be obtained that a color gamut necessary for the printing can be more easily realized.

Mode 8: A printing support system according to mode 8, in the printing support system according to mode 7, further includes:

a recording agent color gamut calculation unit that calculates, based on recording agent information of the recording agent information memory unit, from a color gamut that each of a plurality of the recording agents can represent, a color gamut that a mixed color of the recording agents can represent;

wherein the adaptation judgment unit calculates, based on results calculated at the recording agent color gamut calculation unit, a degree at which a color gamut that the recording agent can represent covers a color gamut calculated at the printing color gamut calculation unit, and, from a degree of covering the calculated color gamut and a degree adapting to the inputted or judged characteristics, an evaluation value; and

the recording agent presentation unit presents the recording agents or combinations thereof in descending order of the evaluation values calculated at the adaptation judgment unit.

When the printing support system is so configured, the recording agent color gamut calculation unit calculates, based on the recording agent information of the recording agent information memory unit, from a color gamut that each of the plurality of recording agents can represent, a color gamut that a mixed color of the recording agents can represent. Next, the adaptation judgment unit calculates, based on results calculated at the recording agent color gamut calculation unit, a degree at which a color gamut that the recording agent can represent covers the calculated color gamut, and, from a degree that cover the calculated color gamut and a degree adapting to the inputted or judged characteristics, an evaluation value. Then, the recording agent presentation unit presents the recording agents or the combinations thereof in descending order of calculated evaluation values.

Thereby, an advantage can be obtained identical to that of the printing support system according to mode 6.

Mode 9: A printing support system according to mode 9 is a printing support system that supports using a recording agent to print.

The printing support system includes:

a recording agent information memory unit that memorizes recording agent information of the characteristics of a plurality of the recording agents;

a characteristics input unit that inputs the characteristics of the recording agent;

an adaptation judgment unit that judges, based on the recording agent information of the recording agent information memory unit, among the plurality of recording agents, one that adapts to the characteristics inputted at the characteristics input unit; and

a recording agent selection unit that selects a recording agent that is judged at the adaptation judgment unit among the plurality of recording agents.

When the printing support system is so configured and the characteristics of the recording agent are input at the characteristics input unit, the adaptation judgment unit judges, based on the recording agent information of the recording agent information memory unit, one that adapts to the inputted characteristics among the plurality of recording agents, and the recording agent selection unit selects the judged recording agent among the plurality of recording agents.

Thereby, when the selected recording agent is used to print, an advantage can be obtained that the appropriate characteristics corresponding to a usage environment of the printed matters can be realized most easily. Furthermore, since the only necessity is to replace the recording agent, there is no need of disposing many recording agent holding units in the printer. Accordingly, there is an advantage in that a structure of the printer does not become complicated.

Mode 10: A printing support system according to mode 10 is a printing support system that supports using a recording agent to print.

The printing support system includes:

a recording agent information memory unit that memorizes recording agent information of the characteristics of a plurality of the recording agents;

a usage environment input unit that inputs a usage environment of a printed matter;

a characteristics judgment unit that judges, based on the usage environment inputted at the usage environment input unit, the characteristics necessary for the recording agent;

an adaptation judgment unit that judges, based on the recording agent information of the recording agent information memory unit, among the plurality of the recording agents, one that adapts to the characteristics judged at the characteristics judgment unit; and

a recording agent selection unit that selects, among the plurality of the recording agents, a recording agent that is judged at the adaptation judgment unit.

When the printing support system is thus configured and the usage environment of the printed matter is input at the usage environment input unit, the characteristics judgment unit judges, based on the inputted usage environment, the characteristics necessary for the recording agent. Then, the adaptation judgment unit judges, based on the recording agent information of the recording agent information memory unit, among the plurality of recording agents, one that adapts to the judged characteristics, and the recording agent selection unit selects the judged recording agent from the plurality of recording agents.

Thereby, when the selected recording agent is used to print, an advantage can be obtained that the appropriate characteristics corresponding to a usage environment of the printed matters can be realized most easily. Furthermore, since the only necessity is to replace the recording agent, there is no need of disposing many recording agent holding units in the printer. Accordingly, there is an advantage in that a structure of the printer does not become complicated.

Mode 11: A printing support system according to mode 11, in the printing support system according to mode 10, further includes:

a recording agent requirement characteristics information memory unit that memorizes recording agent requirement characteristics information about the characteristics necessary for the recording agent for each of the usage environments of printed matters;

wherein the characteristics judgment unit judges, based on the recording agent requirement characteristics information of the recording agent requirement characteristics information memory unit, the characteristics necessary for the recording agent.

When the printing support system is so configured, an operation and advantage can be obtained identical as that of the printing support system according to mode 3.

Mode 12: A printing support system according to mode 12, in the printing support system according to any one of modes 9 through 11, further includes:

a printing color gamut calculation unit that calculates, based on printing data, a color gamut necessary for printing;

wherein the adaptation judgment unit calculates, based on the recording agent information of the recording agent information memory unit, a degree at which a color gamut that the recording agent can represent covers the color gamut calculated at the printing color gamut calculation unit, and, from a degree that covers the calculated color gamut and a degree adapting to the inputted or judged characteristics, an evaluation values; and

the recording agent selection unit selects the recording agent or the combination thereof having the largest evaluation value calculated at the adaptation judgment unit.

When the printing support unit is so configured, the printing color gamut calculation unit calculates, based on the printing data, a color gamut necessary for printing. Next, the adaptation judgment unit calculates, based on the recording agent information of the recording agent information memory unit, a degree at which a color gamut that the recording agent can represent covers the calculated color gamut, and, from a degree covering the calculated color gamut and a degree adapting to the inputted or judged characteristics, an evaluation values. The recording agent selection unit selects the recording agent or the combination thereof having the largest calculated evaluation value.

Thereby, the recording agent or combination thereof adapted to the color gamut necessary for the printing can be selected. Accordingly, an advantage can be obtained that the color gamut necessary for the printing becomes easier to realize.

Here, the adaptation judgment unit and the recording agent selection unit calculate, when the recording agent is selected based on the recording agent information about the characteristics other than the color gamut of the recording agent, for instance, based on the recording agent information, a color gamut that each of the recording agents can represent, and can select a recording agent based on the calculated results.

Mode 13: A printing support system according to mode 13, in the printing support system according to mode 12, further includes:

a recording agent color gamut calculation unit that calculates, based on recording agent information of the recording agent information memory unit, from a color gamut that each of a plurality of the recording agents can represent, a color gamut that a mixed color of the recording agents can represent;

wherein the adaptation judgment unit calculates, based on results calculated at the recording agent color gamut calculation unit, a degree at which a color gamut that the recording agent can represent covers a color gamut calculated at the printing color gamut calculation unit, and, from a degree of covering the calculated color gamut and a degree adapting to the inputted or judged characteristics, an evaluation value; and

the recording agent selection unit selects a recording agent or a combination thereof having the largest evaluation value calculated at the adaptation judgment unit.

When the printing support system is so configured, the recording agent color gamut calculation unit calculates, based on the recording agent information of the recording agent information memory unit, from a color gamut that each of the plurality of recording agents can represent, a color gamut that a mixed color of the recording agents can represent. Next, the adaptation judgment unit calculates, based on results calculated at the recording agent color gamut calculation unit, a degree at which the color gamut that the recording agent can represent covers the calculated color gamut, and, from a degree that covers the calculated color gamut and a degree adapting to the inputted or judged characteristics, an evaluation value. Then, the recording agent selection unit selects the recording agent or the combination thereof having the largest evaluation value.

Thereby, a color gamut when a plurality of recording agents is combined can be calculated. As a result, a plurality of recording agents or combinations thereof that adapt to a color gamut necessary for the printing can be selected. Accordingly, an advantage can be obtained that a color gamut necessary for the printing can be more easily realized.

Mode 14: A printing support system according to mode 14 is the printing support system according to any one of modes 1 through 13,

wherein the recording agent information includes information showing the image quality characteristics, weather resistance characteristics, kinds of applicable printing media, performances of applicable printers, costs or environment adaptation characteristics.

When the printing support system is thus configured, a recording agent that adapts to the image quality characteristics, weather resistance characteristics, kinds of applicable printing media, performances of applicable printers, costs or environment adaptation characteristics is presented or selected.

Thereby, an advantage can be obtained that the image quality characteristics, weather resistance characteristics, kinds of applicable printing media, performances of applicable printers, costs or environment adaptation characteristics can be more easily realized.

Mode 15: A printing support system according to mode 15 is the printing support system according to any one of modes 1 through 14;

wherein the recording agent information includes identification information of the recording agent; and

the recording agent presentation unit presents the identification information of the recording agent.

When the printing support system is so configured, the recording agent presentation unit presents the identification information of the recording agent.

Here, as the identification information of the recording agent, for instance, a diagram in which the recording agent is schematized, a link address of the information of the recording agent, or a name, a number or ID of the recording agent is considered. In what follows, this is the same in a printing support program according to mode 36 and a printing support method according to mode 51.

Mode 16: On the other hand, in order to achieve the advantage of the invention, a printer according to mode 16 is a printer that includes a recording agent holding unit that holds a recording agent and a printing control unit that carries out printing control based on printing data, and uses a recording agent held by the recording agent holding unit to print.

The printer further includes:

a recording agent information memory unit that memorizes recording agent information of the characteristics of a plurality of the recording agents;

a characteristics input unit that inputs the characteristics of the recording agent;

an adaptation judgment unit that judges, based on the recording agent information in the recording agent information memory unit, among the plurality of recording agents, one that adapts to the characteristics inputted at the characteristics input unit; and

a recording agent presentation unit that presents a recording agent judged at the adaptation judgment unit.

When the printer is so configured and the characteristics of the recording agent are input at the characteristics input unit, the adaptation judgment unit judges, based on the recording agent information of the recording agent information memory unit, among the plurality of recording agents, one that adapts to the inputted characteristics, and the recording agent presentation unit presents judged recording agent. When a user supplies a presented recording agent to the recording agent holding unit, the printing control unit, based on the printing data, uses the recording agent held by the recording agent holding unit to print.

Thereby, an advantage identical as that of the printing support system according to mode 1 can be obtained.

Here, as the recording agent holding unit, for instance, when the printer is an ink jet printer or a laser printer, a cartridge holder to which a recording agent cartridge in which a recording agent is filled can be installed is included, and when the printer is a large-scale printer, a recording agent storing unit that stores the recording agent is included. In what follows, the situation is the same in printers according to modes 17 through 19.

Mode 17: A printer according to mode 17 is a printer that includes a recording agent holding unit that holds a recording agent and a printing control unit that carries out printing control based on printing data, and uses a recording agent held by the recording agent holding unit to print.

The printer further includes:

a recording agent information memory unit that memorizes recording agent information of the characteristics of a plurality of the recording agents;

a usage environment input unit that inputs a usage environment of a printed matter;

a characteristics judgment unit that judges, based on the usage environment inputted at the usage environment input unit, the characteristics necessary for the recording agent;

an adaptation judgment unit that judges, based on the recording agent information in the recording agent information memory unit, among the plurality of recording agents, one that adapts to the characteristics judged at the characteristics judgment unit; and

a recording agent presentation unit that presents a recording agent judged at the adaptation judgment unit.

When the printer is so configured and the usage environment input unit inputs the usage environment of the printed matter, the characteristics judgment unit judges, based on the inputted usage environment, the characteristics necessary for the recording agent. Then, the adaptation judgment unit judges, based on the recording agent information of the recording agent information memory unit, among the plurality of recording agents, one that adapts to the judged characteristics, and the recording agent presentation unit presents the judged recording agent. When a user supplies a presented recording agent to the recording agent holding unit, the printing control unit, based on the printing data, uses the recording agent held by the recording agent holding unit to print.

Thereby, an advantage identical as that of the printing support system according to mode 2 can be obtained.

Mode 18: A printer according to mode 18 is a printer that includes a recording agent holding unit that holds a recording agent and a printing control unit that carries out printing control based on printing data, and uses a recording agent held by the recording agent holding unit to print.

The printer further includes:

a recording agent information memory unit that memorizes recording agent information of the characteristics of a plurality of the recording agents;

a characteristics input unit that inputs the characteristics of the recording agent;

an adaptation judgment unit that judges, based on the recording agent information of the recording agent information memory unit, among the plurality of recording agents, one that adapts to the characteristics inputted at the characteristics input unit; and

a recording agent selection unit that selects, among the plurality of recording agents, a recording agent that is judged at the adaptation judgment unit.

When the printer is so configured and the characteristics input unit inputs the characteristics of the recording agent, the adaptation judgment unit judges, based on the recording agent information of the recording agent information memory unit, among the plurality of recording agents, one that adapts to the inputted characteristics, and the recording agent selection unit selects, among the plurality of recording agents, the judged recording agent. When the selected recording agent is supplied to the recording agent holding unit, the printing control unit, based on the printing data, uses the recording agent held by the recording agent holding unit to print.

Thereby, an advantage identical as that of the printing support system according to mode 9 can be obtained.

Mode 19: A printer according to mode 19 is a printer that includes a recording agent holding unit that holds a recording agent and a printing control unit that carries out printing control based on printing data, and uses a recording agent held by the recording agent holding unit to print.

The printer further includes:

a recording agent information memory unit that memorizes recording agent information of the characteristics of a plurality of the recording agents;

a usage environment input unit that inputs a usage environment of a printed matter;

a characteristics judgment unit that judges, based on the usage environment inputted at the usage environment input unit, the characteristics necessary for the recording agent;

an adaptation judgment unit that judges, based on the recording agent information of the recording agent information memory unit, among the plurality of recording agents, one that adapts to the characteristics judged at the characteristics judgment unit; and

a recording agent selection unit that selects, among the plurality of recording agents, a recording agent judged at the adaptation judgment unit.

When the printer is so configured and the usage environment input unit inputs the usage environment of the printed matter, the characteristics judgment unit judges, based on the inputted usage environment, the characteristics necessary for the recording agent. Then, the adaptation judgment unit judges, based on the recording agent information of the recording agent information memory unit, among the plurality of recording agents, one that adapts to the judged characteristics, and the recording agent selection unit selects judged recording agent among the plurality of recording agents. When the selected recording agent is supplied to the recording agent holding unit, the printing control unit, based on the printing data, uses the recording agent held by the recording agent holding unit to print.

Thereby, an advantage identical as that of the printing support system according to mode 10 can be obtained.

Mode 20: A printer according to mode 20 is, in any one of the printers according to modes 16 through 19, an ink jet printer.

When thus configured, owing to a printing control unit, ink as a recording agent is discharged to print.

Mode 21: A printer according to mode 21 is, in any one of the printers according to modes 16 through 19, a laser printer.

When thus configured, owing to a printing control unit, a toner as a recording agent is transcribed with a laser to print.

Mode 22: On the other hand, in order to achieve the advantage of the invention, a printing support program according to mode 22 is a printing support program that supports using a recording agent to print.

The printing support program includes:

a program that makes a computer execute a process including;

inputting characteristics for inputting the characteristics of the recording agent;

judging adaptation for judging, based on recording agent information of a recording agent information memory unit that memorizes recording agent information of the characteristics of a plurality of the recording agents, among the plurality of recording agents, one that adapts to the characteristics inputted at the inputting characteristics; and

presenting recording agent for presenting a recording agent judged at the judging adaptation.

When the printing support program is thus configured and the computer reads a program and executes a process according to a read program, an operation and advantage identical as that of the printing support system according to mode 1 can be obtained.

Mode 23: A printing support program according to mode 23 is a printing support program that supports using a recording agent to print.

The printing support program includes:

a program that makes a computer execute a process including;

inputting usage environment for inputting a usage environment of a printed matter;

judging characteristics for judging, based on the usage environment inputted at the inputting usage environment, the characteristics necessary for the recording agent;

judging adaptation for judging, based on recording agent information of a recording agent information memory unit that memorizes recording agent information of the characteristics of a plurality of the recording agents, among the plurality of recording agents, one that adapts to the characteristics judged at the judging characteristics; and

presenting recording agent for presenting a recording agent judged at the judging adaptation.

When the printing support program is thus configured and the computer reads the program and executes a process according to a read program, an operation and advantage identical as that of the printing support system according to mode 2 can be obtained.

Mode 24: A printing support program according to mode 24 is the printing support program according to the mode 23;

wherein the judging characteristics judges, based on recording agent requirement characteristics information of a recording agent requirement characteristics information memory unit that memorizes the recording agent requirement characteristics information of the characteristics necessary for the recording agent for each of usage environments of the printed matters, the characteristics necessary for the recording agent.

When the printing support program is thus configured and the computer reads a program and executes a process according to a read program, an operation and advantage identical as that of the printing support system according to mode 3 can be obtained.

Mode 25: A printing support program according to mode 25, in the printing support program according to any one of modes 22 through 24, further includes:

a program that makes a computer execute a process made of calculating printing color gamut for calculating a color gamut necessary for printing based on printing data;

wherein the judging adaptation calculates, based on a color gamut that the recording agent can represent and a color gamut calculated at the calculating printing color gamut, an evaluation value; and

the presenting recording agent presents, based on the evaluation value calculated at the judging adaptation, a recording agent or a combination thereof.

When the printing support program is thus configured and the computer reads a program and executes a process according to a read program, an operation and advantage identical as that of the printing support system according to mode 4 can be obtained.

Mode 26: A printing support program according to mode 26, in the printing support program according to any one of modes 22 through 25, further includes:

a program that makes a computer execute a process made of calculating printing color gamut for calculating a color gamut necessary for printing based on printing data;

wherein the judging adaptation calculates, based on recording agent information of the recording agent information memory unit, a degree at which a color gamut that the recording agent can represent covers a color gamut calculated at the calculating printing color gamut, and, from a degree of covering the calculated color gamut and a degree that adapts to the inputted or judged characteristics, an evaluation value; and

the presenting recording agent presents a recording agent or a combination thereof having the largest evaluation value calculated at the judging adaptation.

When the printing support program is thus configured and the computer reads a program and executes a process according to a read program, an operation and advantage identical as that of the printing support system according to mode 5 can be obtained.

Here, the judging adaptation and the presenting recording agent calculate, when the recording agent is presented based on the recording agent information of the characteristics other than the color gamut of the recording agent, for instance, based on the recording agent information, a color gamut that each of the recording agents can represent, and can present the recording agent based on the calculation result. In what follows, this is the same in a printing support program according to mode 28, and in printing support methods according to modes 41 and 43.

Mode 27: A printing support program according to mode 27, in the printing support program according to mode 26, further includes:

a program that makes a computer execute a process made of calculating recording agent color gamut for calculating, based on recording agent information of the recording agent information memory unit, from a color gamut that each of a plurality of the recording agents can represent, a color gamut that a mixed color of the recording agents can represent;

wherein the judging adaptation calculates, based on result calculated at the calculating recording agent color gamut, a degree at which a color gamut that the recording agent can represent covers a color gamut calculated at the calculating printing color gamut, and, from a degree of covering the calculated color gamut and a degree that adapts to the inputted or judged characteristics, an evaluation value; and

the presenting recording agent presents a recording agent or a combination thereof having the largest evaluation value calculated at the judging adaptation.

When the printing support program is thus configured and the computer reads a program and executes a process according to a read program, an operation and advantage identical as that of the printing support system according to mode 6 can be obtained.

Mode 28: A printing support program according to mode 28, in the printing support program according to any one of modes 22 through 25, further includes:

a program that makes a computer execute a process made of calculating printing color gamut for calculating a color gamut necessary for printing based on printing data;

wherein the judging adaptation calculates, based on recording agent information of the recording agent information memory unit, a degree at which a color gamut that the recording agent can represent covers a color gamut calculated at the calculating printing color gamut, and, from a degree of covering the calculated color gamut and a degree that adapts to the inputted or judged characteristics, an evaluation value; and

the presenting recording agent presents recording agents or combinations thereof in descending order of the evaluation values calculated at the judging adaptation.

When the printing support program is thus configured and the computer reads a program and executes a process according to a read program, an operation and advantage identical as that of the printing support system according to mode 7 can be obtained.

Mode 29: A printing support program according to mode 29, in the printing support program according to mode 28, further includes:

a program that makes a computer execute a process made of calculating recording agent color gamut for calculating, based on recording agent information of the recording agent information memory unit, from a color gamut that each of a plurality of the recording agents can represent, a color gamut that a mixed color of the recording agents can represent;

wherein the judging adaptation calculates, based on the result calculated at the calculating recording agent color gamut, a degree at which a color gamut that the recording agent can represent covers a color gamut calculated at the calculating printing color gamut, and, from a degree of covering the calculated color gamut and a degree that adapts to the inputted or judged characteristics, an evaluation value; and

the presenting recording agent presents recording agents or combinations thereof in descending order of the evaluation values calculated at the judging adaptation.

When the printing support program is thus configured and the computer reads a program and executes a process according to a read program, an operation and advantage identical as that of the printing support system according to mode 8 can be obtained.

Mode 30: A printing support program according to mode 30 is a printing support program that supports using a recording agent to print and includes:

a program that makes a computer execute a process including;

inputting characteristics for inputting the characteristics of the recording agent;

judging adaptation for judging, based on recording agent information of a recording agent information memory unit that memorizes the recording agent information about the characteristics of a plurality of the recording agents, among the plurality of recording agents, one that adapts to the characteristics inputted at the inputting characteristics; and

selecting recording agent for selecting a recording agent judged at the judging adaptation among the plurality of recording agents.

When the printing support program is thus configured and the computer reads the program and executes the process according to a read program, an operation and advantage identical as that of the printing support system according to mode 9 can be obtained.

Mode 31: A printing support program according to mode 31 is a printing support program that supports using a recording agent to print and includes:

a program that makes a computer execute a process including;

inputting usage environment for inputting a usage environment of a printed matter;

judging characteristics for judging, based on the usage environment inputted at the inputting usage environment, the characteristics necessary for the recording agent;

judging adaptation for judging, based on recording agent information of a recording agent information memory unit that memorizes the recording agent information about the characteristics of a plurality of the recording agents, among the plurality of recording agents, one that adapts to the characteristics judged at the judging characteristics; and

selecting recording agent for selecting a recording agent judged at the judging adaptation among the plurality of recording agents.

When the printing support program is thus configured and the computer reads the program and executes the process according to a read program, an operation and advantage identical as that of the printing support system according to mode 10 can be obtained.

Mode 32: A printing support program according to mode 32 is the printing support program according to mode 31;

wherein the judging characteristics judges, based on recording agent requirement characteristics information of a recording agent requirement characteristics memory unit that memorizes the recording agent requirement characteristics information of the characteristics necessary for the recording agent for each of usage environments of the printed matters, the characteristics necessary for the recording agent.

When the printing support program is thus configured and the computer reads the program and executes the process according to a read program, an operation and advantage identical as that of the printing support system according to mode 11 can be obtained.

Mode 33: A printing support program according to mode 33 is the printing support program according to any one of modes 30 through 32 and further includes:

a program that makes a computer execute a process made of calculating printing color gamut for calculating a color gamut necessary for printing based on printing data;

wherein judging adaptation calculates, based on recording agent information of the recording agent information memory unit, a degree at which a color gamut that the recording agent can represent covers a color gamut calculated at the calculating printing color gamut, and, from a degree that covers the calculated color gamut and a degree that adapts to the inputted or judged characteristics, an evaluation value; and

selecting recording agent selects a recording agent or a combination thereof having the largest evaluation value calculated at the judging adaptation.

When the printing support program is thus configured and the computer reads the program and executes the process according to a read program, an operation and advantage identical as that of the printing support system according to mode 12 can be obtained.

Here, the judging adaptation and the selecting recording agent calculate, when the recording agent is selected based on the recording agent information of the characteristics other than the color gamut of the recording agent, for instance, based on the recording agent information, a color gamut that each of the recording agents can represent, and can select the recording agent based on the calculation result. In what follows, this is the same in a printing support method according to mode 48.

Mode 34: A printing support program according to mode 34 is the printing support program according to the mode 33 and further includes:

a program that makes a computer execute, based on recording agent information of the recording agent information memory unit, a process made of calculating recording agent color gamut for calculating a color gamut that a mixed color of the recording agents can represent from a color gamut that each of a plurality of the recording agents can represent;

wherein judging adaptation calculates, based on calculated result at the calculating recording agent color gamut, a degree at which a color gamut that the recording agent can represent covers a color gamut calculated at the calculating printing color gamut, and, from a degree that covers the calculated color gamut and a degree that adapts to the inputted or judged characteristics, an evaluation value; and

selecting recording agent selects a recording agent or a combination thereof having the largest evaluation value calculated at the judging adaptation.

When the printing support program is thus configured and the computer reads the program and executes the process according to a read program, an operation and advantage identical as that of the printing support system according to mode 13 can be obtained.

Mode 35: A printing support program according to mode 35 is the printing support program according to any one of modes 22 through 34; wherein

the recording agent information includes information showing the image quality characteristics, weather resistance characteristics, kinds of applicable printing media, performances of applicable printers, costs or environment adaptation characteristics.

When the printing support program is thus configured and the computer reads the program and executes the process according to a read program, an operation and advantage identical as that of the printing support system according to mode 14 can be obtained.

Mode 36: A printing support program according to mode 36 is the printing support program according to any one of modes 22 through 35; wherein

the recording agent information includes identification information of the recording agent; and

the presenting recording agent presents the identification information of the recording agent.

When the printing support program is thus configured and the computer reads the program and executes the process according to a read program, an operation and advantage identical as that of the printing support system according to mode 15 can be obtained.

Mode 37: On the other hand, in order to achieve the advantage of the invention, a printing support method according to mode 37 is a printing support method that supports using a recording agent to print and includes:

inputting characteristics for inputting the characteristics of the recording agent;

judging adaptation for judging, based on recording agent information of a recording agent information memory unit that memorizes the recording agent information of the characteristics of a plurality of the recording agents, among the plurality of recording agents, one that adapts to the characteristics inputted at the inputting characteristics; and

presenting recording agent for presenting a recording agent judged at the judging adaptation.

Thereby, an advantage identical as that of the printing support system according to the mode 1 can be obtained.

Mode 38: A printing support method according to mode 38 is a printing support method that supports using a recording agent to print and includes:

inputting usage environment for inputting a usage environment of a printed matter;

judging characteristics for judging, based on the usage environment inputted at the inputting usage environment, the characteristics necessary for the recording agent;

judging adaptation for judging, based on recording agent information of a recording agent information memory unit that memorizes the recording agent information of the characteristics of a plurality of the recording agents, among the plurality of recording agents, one that adapts to the characteristics judged at the judging characteristics; and

presenting recording agent for presenting a recording agent judged at the judging adaptation.

Thereby, an advantage identical as that of the printing support system according to mode 2 can be obtained.

Mode 39: A printing support method according to mode 39 is the printing support method according to mode 38;

wherein the judging characteristics judges, based on recording agent requirement characteristics information of a recording agent requirement characteristics information memory unit that memorizes the recording agent requirement characteristics information of the characteristics necessary for the recording agent for each of usage environments of the printed matters, the characteristics necessary for the recording agent.

Thereby, an advantage identical as that of the printing support system according to mode 3 can be obtained.

Mode 40: A printing support method according to mode 40 is the printing support method according to any one of modes 37 through 39 and further includes:

calculating printing color gamut for calculating a color gamut necessary for printing based on printing data;

wherein the judging adaptation calculates, based on a color gamut that the recording agent can represent and a color gamut calculated at the calculating the printing color gamut, an evaluation value; and

the presenting recording agent presents, based on the evaluation value calculated at the judging adaptation, a recording agent or a combination thereof.

Thereby, an advantage identical as that of the printing support system according to mode 4 can be obtained.

Mode 41: A printing support method according to mode 41 is the printing support method according to any one of modes 37 through 40 and further includes:

calculating printing color gamut for calculating a color gamut necessary for printing based on printing data;

wherein the judging adaptation calculates, based on recording agent information of the recording agent information memory unit, a degree at which a color gamut that the recording agent can represent covers a color gamut calculated at the calculating the printing color gamut, and, from a degree that covers the calculated color gamut and a degree that adapts to the inputted or judged characteristics, an evaluation value; and

the presenting recording agent presents a recording agent or a combination thereof having the largest evaluation value calculated at the judging adaptation.

Thereby, an advantage identical as that of the printing support system according to mode 5 can be obtained.

Mode 42: A printing support method according to mode 42 is the printing support method according to mode 41 and further includes:

calculating recording agent color gamut for calculating, based on recording agent information of the recording agent information memory unit, from a color gamut that each of a plurality of recording agents can represent, a color gamut that a mixed color of the recording agents can represent;

wherein the judging adaptation calculates, based on the result calculated at the calculating recording agent color gamut, a degree at which a color gamut that the recording agent can represent covers a color gamut calculated at the calculating printing color gamut, and, from a degree that covers the calculated color gamut and a degree that adapts to the inputted or judged characteristics, an evaluation value; and

the presenting recording agent presents a recording agent or a combination thereof having the largest evaluation value calculated at the judging adaptation.

Thereby, an advantage identical as that of the printing support system according to mode 6 can be obtained.

Mode 43: A printing support method according to mode 43 is the printing support method according to any one of modes 37 through 40 and further includes:

calculating printing color gamut for calculating a color gamut necessary for printing based on printing data;

wherein the judging adaptation calculates, based on recording agent information of the recording agent information memory unit, a degree at which a color gamut that the recording agent can represent covers a color gamut calculated at the calculating the printing color gamut, and, from a degree covering the calculated color gamut and a degree adapting to the inputted or judged characteristics, an evaluation value; and

the presenting recording agent presents the recording agents or the combinations thereof in descending order of the evaluation values calculated at the judging adaptation.

Thereby, an advantage identical as that of the printing support system according to mode 7 can be obtained.

Mode 44: A printing support method according to mode 44 is the printing support method according to mode 43 and further includes:

calculating recording agent color gamut for calculating, based on recording agent information of the recording agent information memory unit, from a color gamut that each of a plurality of the recording agents can represent, a color gamut that a mixed color of the recording agents can represent;

wherein the judging adaptation calculates, based on the result calculated at the calculating recording agent color gamut, a degree at which a color gamut that the recording agent can represent covers a color gamut calculated at the calculating the printing color gamut, and, from a degree covering the calculated color gamut and a degree adapting to the inputted or judged characteristics, an evaluation value; and

the presenting recording agent presents the recording agents or the combinations thereof in descending order of the evaluation values calculated at the judging adaptation.

Thereby, an advantage identical as that of the printing support system according to mode 8 can be obtained.

Mode 45: A printing support method according to mode 45 is a printing support method that supports using a recording agent to print and includes:

inputting characteristics for inputting the characteristics of the recording agent;

judging adaptation for judging, based on recording agent information of a recording agent information memory unit that memorizes the recording agent information of the characteristics of a plurality of the recording agents, among the plurality of recording agents, one that adapts to the characteristics inputted at the inputting characteristics; and

selecting recording agent for selecting a recording agent judged at the judging adaptation from the plurality of recording agents.

Thereby, an advantage identical as that of the printing support system according to the mode 9 can be obtained.

Mode 46: A printing support method according to mode 46 is a printing support method that supports using a recording agent to print and includes:

inputting usage environment for inputting a usage environment of a printed matter;

judging characteristics for judging, based on the usage environment inputted at the inputting usage environment, the characteristics necessary for the recording agents;

judging adaptation for judging, based on recording agent information of a recording agent information memory unit that memorizes the recording agent information of the characteristics of a plurality of the recording agents, among the plurality of recording agents, one that adapts to the characteristics judged at the judging characteristics; and

selecting recording agent for selecting a recording agent judged at the judging adaptation among the plurality of recording agents.

Thereby, an advantage identical as that of the printing support system according to the mode 10 can be obtained.

Mode 47: A printing support method according to mode 47 is the printing support method according to mode 46;

wherein the judging characteristics judges, based on recording agent requirement characteristics information of a recording agent requirement characteristics information memory unit that memorizes the recording agent requirement characteristics information about the characteristics necessary for the recording agent for each of usage environments of the printed matter, the characteristics necessary for the recording agents.

Thereby, an advantage identical as that of the printing support system according to the mode 11 can be obtained.

Mode 48: A printing support method according to mode 48 is the printing support method according to any one of modes 45 through 47 and further includes:

calculating printing color gamut for calculating a color gamut necessary for printing based on printing data;

wherein the judging adaptation calculates, based on recording agent information of the recording agent information memory unit, a degree at which a color gamut that the recording agent can represent covers a color gamut calculated at the calculating printing color gamut, and, from a degree that covers the calculated color gamut and a degree that adapts to the inputted or judged characteristics, an evaluation value; and

the selecting recording agent selects a recording agent or a combination thereof having the largest evaluation value calculated at the judging adaptation.

Thereby, an advantage identical as that of the printing support system according to the mode 12 can be obtained.

Mode 49: A printing support method according to mode 49 is the printing support method according to mode 48 and further includes:

calculating recording agent color gamut for calculating, based on recording agent information of the recording agent information memory unit, from a color gamut that each of a plurality of the recording agents can represent, a color gamut that a mixed color of the recording agents can represent;

wherein the judging adaptation calculates, based on the result calculated at the calculating recording agent color gamut, a degree at which a color gamut that the recording agent can represent covers a color gamut calculated at the calculating the printing color gamut, and, from a degree covering the calculated color gamut and a degree that adapts to the inputted or judged characteristics, an evaluation value; and

the selecting recording agent selects a recording agent or a combination thereof having the largest evaluation value calculated at the judging adaptation.

Thereby, an advantage identical as that of the printing support system according to mode 13 can be obtained.

Mode 50: A printing support method according to a mode 50 is the printing support method according to any one of modes 37 through 49;

wherein the recording agent information includes information showing the image quality characteristics, weather resistance characteristics, kinds of applicable printing media, performances of applicable printers, costs or environment adaptation characteristics.

Thereby, an advantage identical as that of the printing support system according to mode 14 can be obtained.

Mode 51: A printing support method according to mode 51 is the printing support methods according to any one of modes 37 through 50;

wherein the recording agent information includes identification information of the recording agent; and

the presenting recording agent presents the identification information of the recording agents.

Thereby, an advantage same as that of the printing support system according to the mode 15 can be obtained.

### BRIEF DESCRIPTION OF THE DRAWINGS

The invention will be described with reference to the accompanying drawings, wherein like numbers reference like elements.

FIG. 1 is a functional block diagram showing a configuration of an ink jet printer 100.

FIG. 2 is a graph showing a color gamut with an xy chromaticity diagram.

FIG. 3 is a block diagram showing a hardware configuration of the ink jet printer 100.

FIG. 4 is a diagram showing a data structure of an ink cartridge information registration table 400.

FIG. 5 is a flow chart showing a process of presenting an ink cartridge.

FIG. 6 is a diagram showing an input screen where the ink characteristics are input.

FIG. 7 is a diagram showing another input screen where the ink characteristics are input.

FIG. 8 is a table showing calculated results of scores of ink cartridges.

FIG. 9 is a functional block diagram showing a configuration of an ink jet printer 100.

FIG. 10 is a diagram showing a data structure of an ink cartridge information registration table 400.

FIG. 11 is a diagram showing a data structure of an ink requirement characteristics information registration table 480.

FIG. 12 is a flow chart showing a process of presenting an ink cartridge.

FIG. 13 is a diagram showing an input screen where a usage environment is input.

FIG. 14 is a functional block diagram showing a configuration of an ink jet printer 100.

FIG. 15 is a graph showing a color gamut with an xy chromaticity diagram.

FIG. 16 is a functional block diagram showing a configuration of an ink jet printer 100.

FIG. 17 is a functional block diagram showing a configuration of a network system to which the invention is applied.

### DESCRIPTION OF EXEMPLARY EMBODIMENTS

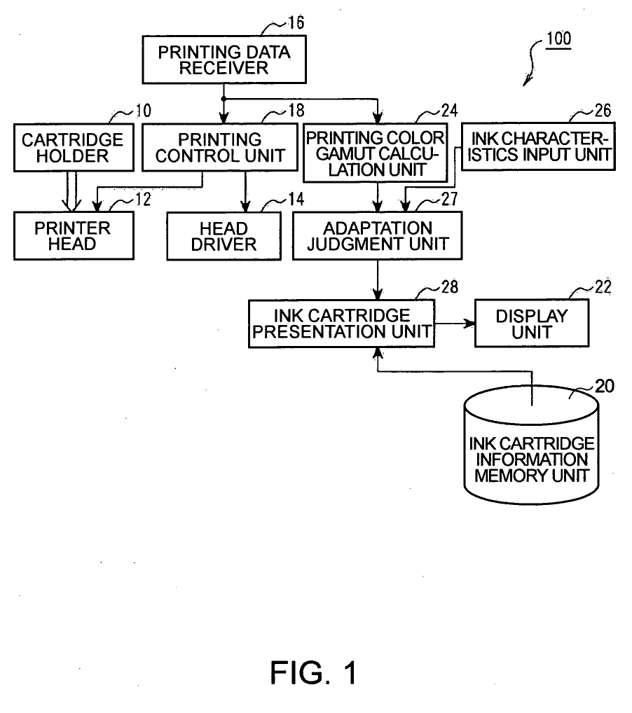

In what follows, a first embodiment according to the invention will be described with reference to the drawings. FIGS. 1 through 8 are diagrams showing first embodiments of a printing support system, a printer and a printing support program, and a printing support method according to the invention.

In the embodiment, a printing support system, a printer and a printing support program, and a printing support method according to the invention, as shown in FIG. 1, are applied to an ink jet printer 100 that is used through a network.

Firstly, a configuration of an ink jet printer 100 to which the invention is applied will be described with reference to FIG. 1.

FIG. 1 is a functional block diagram showing a configuration of the ink jet printer 100.

The ink jet printer 100, as shown in FIG. 1, is constituted including a cartridge holder 10 that can detachably hold an ink cartridge, a printer head 12 that uses ink supplied from the cartridge holder 10 to print on a printing media, a head driver 14 that moves the printer head 12 on a guide rail (not shown in the drawing) disposed perpendicularly to a direction in which the printing media is delivered, a printing data receiver 16 that receives printing data, and a printing controller 18 that controls, based on the printing data received at the printing data receiver 16, the printer head 12 and the head driver 14.

The ink jet printer 100 further includes an ink cartridge information memory unit 20 that stores ink cartridge information showing ink characteristics of each of a plurality of ink cartridges, a display unit 22 made of an LCD (Liquid Crystal Display) or the like, a printing color gamut calculation unit 24 that calculates a color gamut necessary for printing based on the printing data received at the printing data receiver 16, an ink characteristics input unit 26 that inputs the ink characteristics, an adaptation judgment unit 27 that judges one that adapts to the ink characteristics inputted at the ink characteristics input unit 26 among the plurality of ink cartridges and an ink cartridge presentation unit 28 that presents an ink cartridge judged at the adaptation judgment unit 27.

As the printing data, data of optional formats can be adopted. For instance, bit map format image data, JPEG (Joint Photographic coding Experts Group) format compressed image data in which image data are data compressed, or document data such as PDF (Portable Document Format) or Post Script format may be adopted. In addition, independent formats depending on application soft and the ink jet printer 100 may be adopted.

Furthermore, to the printing data, a color profile in which an absolute color to be outputted owing to the printing data is described is added. Here, the absolute color, like a chromaticity value in a CIE L*a*b* color system, shows a color conceived by an observer. On the other hand, the color representation due to the RGB color system and the CMYK color system, because a color outputted by a device is dependent on a device depending on the value thereof, is called a device-dependent color.

The color profile is data that describes correspondence between pixel values (RGB values or CMYK values) showing colors of the respective pixels in the printing data described with device dependent colors and the absolute colors represented when these are actually outputted. Thus, when the absolute colors are used, a color gamut necessary for the printing can be accurately grasped. The color profile, though preferably described with the absolute colors, can be described with the device-dependent colors and other color systems.

When the printing data are described with the device-dependent colors and the color profile is not added, by assuming a color profile, a color gamut necessary for the printing can be grasped. For instance, since an operation in a general PC is carried out almost in accordance with a color profile stipulated by sRGB, as a predetermined value, a color profile due to the sRGB is used, or, in the printing CMYK data, since standard color profiles in the respective countries are used (SWOP in USA, EuroColor in Europe and Magazine Advertising Bureau standard color in Japan), in individual areas or user environments, proper color profiles can be used.

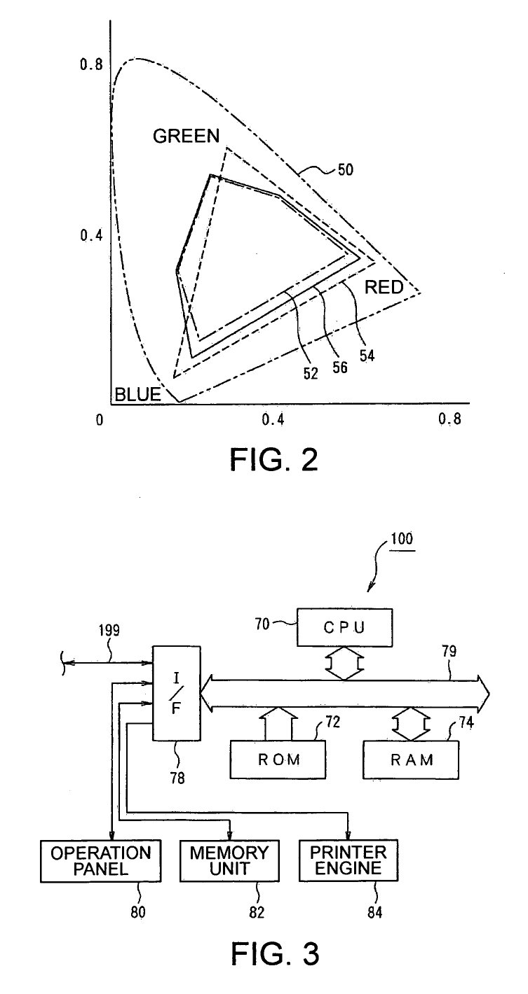

FIG. 2 is a graph in which a color gamut is shown with an xy-chromaticity diagram.

In the embodiment, for convenience sake, an xy-chromaticity diagram is used to show a color gamut. However, in actuality, it is desirable to process in a three-dimensional color space such as an XYZ color diagram or a CIE L*a*b* color diagram.

In FIG. 2, an area 50 surrounded by a chain double-dashed line is a color gamut considered generally perceivable by a human being. Furthermore, an area 52 surrounded by a dashed line shows a color gamut that four color inks of CMYK can represent. Still furthermore, an area 54 surrounded by a dotted line shows a color gamut that the sRGB standard can represent, namely, a color gamut that a display device of a general PC can display. Furthermore, an area 56 surrounded by a solid line shows a color gamut that six color inks of CMYK, red and blue can represent. Thus, depending on various kinds of standards and output methods, representable color gamuts are different.

The ink cartridge information memory unit 20 memorizes (e.g., stores) ink cartridge information showing the ink characteristics for each of the ink cartridges. As the ink characteristics, for instance, the image quality characteristics (color gamut, resolving power, granularity and glossiness), the weather-resistance characteristics (light resistance, gas resistance, water resistance, friction resistance and endurance period), kinds of applicable printing media (paper, film or plastics), performances of an applicable ink jet printer 100 (printing speed), and cost or environment adaptability (use of organic solvents and formaldehyde, and environmental load owing to manufacture, use and disposal) can be cited. For instance, the ink cartridge information of the ink cartridges each of which is filled with one of four color inks of CMYK (hereinafter, simply referred to as “four color ink cartridge”) shows the ink characteristics of the four color inks, in particular, as to the color gamut, the color gamut that the four color inks can represent is shown. Furthermore, the ink cartridge information of the ink cartridges each of which is filled with one of six colors of CMYK, red and blue (hereinafter, simply referred to as “six-color ink cartridge”) shows the ink characteristics of the six-color inks, in particular, the color gamut shows a color gamut that the six-color inks can represent. The format of the memory can be described with indices of the absolute colors such as the CIE L*a*b* color system and Luv color system, and with device-dependent colors and the color profile; however, when the processing load and a representable color gamut are considered, the ink cartridge information is desirably due to a color system similar to the processing color system (hereinafter, simply referred to as “processing color system”) of the ink jet printer 100.

The printing color gamut calculation unit 24 analyses a color gamut necessary for printing based on the printing data. The analysis includes a process of converting a color system of the printing data to the processing color system, and, when the printing data are described with device-dependent colors, a process of converting, with reference to the color profile, the device-dependent colors of the printing data to colors of the processing color system.

For instance, when the printing data is described with the CIE L*a*b* color system that is an index of the absolute color and the processing color system is also the CIE L*a*b* color system, a color gamut necessary for printing in the CIE L*a*b* color system is calculated.

Furthermore, when the printing data is described with the Luv color system that is an index of the absolute color and the processing color system is the CIE L*a*b* color system, by converting Luv values of the printing data to CIE L*a*b* values, a color gamut necessary for printing in the CIE L*a*b* color system is calculated. The conversion from the Luv color system to the CIE L*a*b* color system is defined by a formula.

Still furthermore, in the case of the printing data being described with the RGB color system that is device-dependent color and the processing color system being the CIE L*a*b* color system, when the color profile is appointed to the sRGB, by converting, with reference to the color profile, the RGB values of the printing data to CIE L*a*b* values, a color gamut necessary for printing in the CIE L*a*b* color system is calculated. The conversion from the RGB color system to the CIE L*a*b* color system is defined by a formula.

Thereby, it can be judged that the printing data requires what a range of color in an xy-chromaticity diagram of FIG. 2.

The adaptation judgment unit 27, based on the ink cartridge information of the ink cartridge information memory unit 20, for each of the ink cartridges, calculates a degree at which a color gamut that the inks can represent covers a color gamut calculated at the printing color gamut calculation unit 24 and further calculates a score by weighting and adding a degree covering the calculated color gamut and a degree adapting to the ink characteristics inputted at the ink characteristics input unit 26.

The ink cartridge presentation unit 28 presents an ink cartridge having the largest score calculated at the adaptation judgment unit 27 on the display unit 22.

In what follows, a configuration of the ink jet printer 100 will be described.

FIG. 3 is a block diagram showing a hardware configuration of the ink jet printer 100.

The ink jet printer 100, as shown in FIG. 3, includes a CPU 70 that calculates and controls the whole system based on the control program, a ROM 72 that stores the control program or the like of the CPU 70 in advance in a predetermined area, a RAM 74 that stores data read from the ROM 72 and calculation results necessary in the course of calculation of the CPU 70, and an I/F 78 that mediates input/output of data to an external device. These are mutually connected data-receivable by use of a bus 79 that is a signal line that transfers data.

To the I/F 78, as an external device, an operation panel 80 made of a touch panel or the like that can input and display data as a human-interface, a memory unit 82 that stores data and tables as files, a cartridge holder 10 (FIG. 1), a printer head 12 (FIG. 1), a printer engine 84 made of units necessary for printing such as a head driver 14 (FIG. 1) and others and a signal line for connecting to a network 199 are connected.

The memory unit 82 stores an ink cartridge information registration table 400 for registering ink cartridge information and a plurality of color profiles.

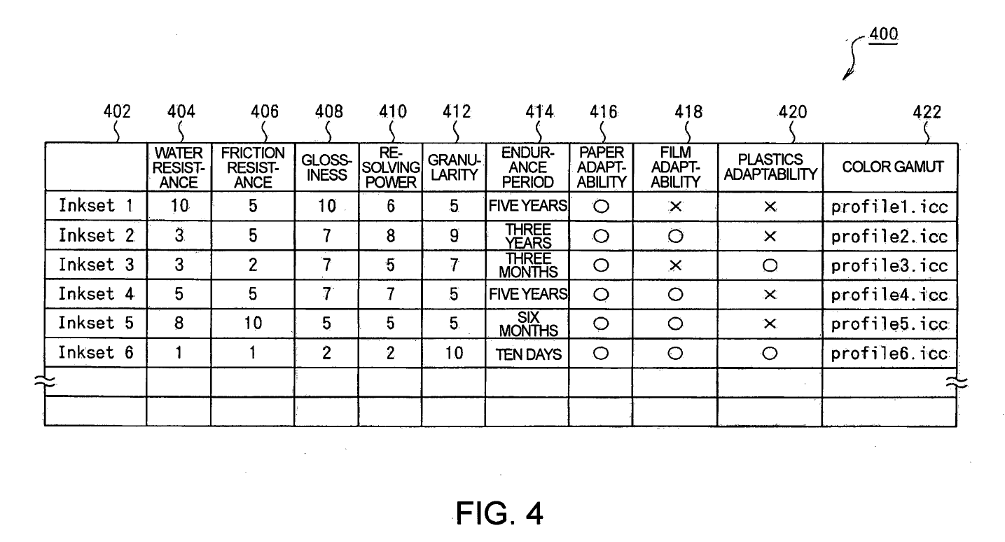

FIG. 4 is a diagram showing a data structure of the ink cartridge information registration table 400.

In the ink cartridge information registration table 400, as shown in FIG. 4, one record is registered for each of the ink cartridges. Each record is constituted including a field 402 where a name of the ink cartridge that is identification information is registered, fields 404 through 414 in each of which the water resistance, friction resistance, glossiness, resolving power, granularity and endurance period (duration of guarantee) are registered respectively, fields 416 through 420 in each of which the printability on paper, film and plastics as the printing media is registered respectively, and a field 422 where a file name of the color profile that shows a color gamut that the ink in the ink cartridge can represent is registered.

In an example shown in FIG. 4, in the record in a first step, “Inkset 1” as a name of the ink cartridge, “10”, “5”, “10”, “6”, “5” and “5 years”, as the water resistance, friction resistance, glossiness, resolving power, granularity and endurance period, “O”, “x” and “x” as the printability on paper, film and plastics, and “profilel.icc” as a file name of the color profile are registered respectively. This shows of the ink cartridge “Inkset1” that the water resistance, friction resistance, glossiness, resolving power, granularity and endurance period, respectively, have above values, the printability is acceptable on paper but neither on film nor on plastics, and a color gamut thereof is defined in the color profile “profile1.icc”. The water resistance, friction resistance, glossiness, resolving power and granularity are shown with numerical values substantially in the range of 1 to 10. As the endurance period, for instance, a duration during which, when a printed matter is left under a predetermined condition, a degree of change of color, ΔE, is below a predetermined value is shown.

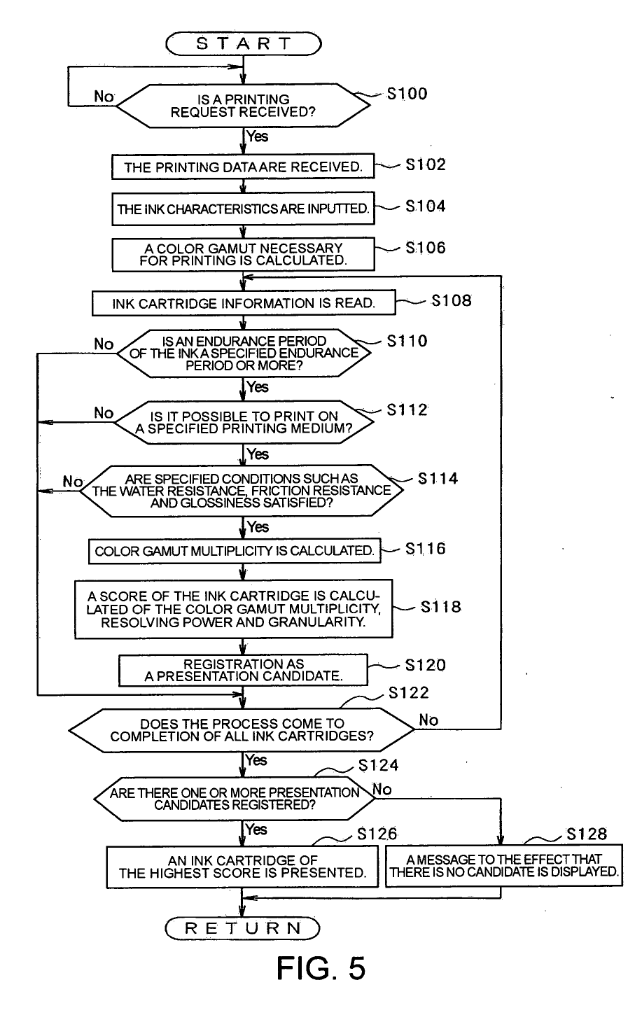

The CPU 70 is made of a micro-processing unit and so on, starts a predetermined program stored in a predetermined region of the ROM 72 and, in accordance with the program, executes an ink cartridge presentation process shown in a flow chart of FIG. 5.

FIG. 5 is a flow chart showing an ink cartridge presentation process.

The ink cartridge presentation process is a process by which among a plurality of ink cartridges an ink cartridge that adapts to the ink characteristics specified by a user is presented. When the process, when carried out in the CPU 70, as shown in FIG. 5, firstly proceeds to step S100.

In step S100, whether a printing request is received or not is judged. When the printing request is judged received (Yes), the process proceeds to step S102 and, after receiving printing data, proceeds to step S104.

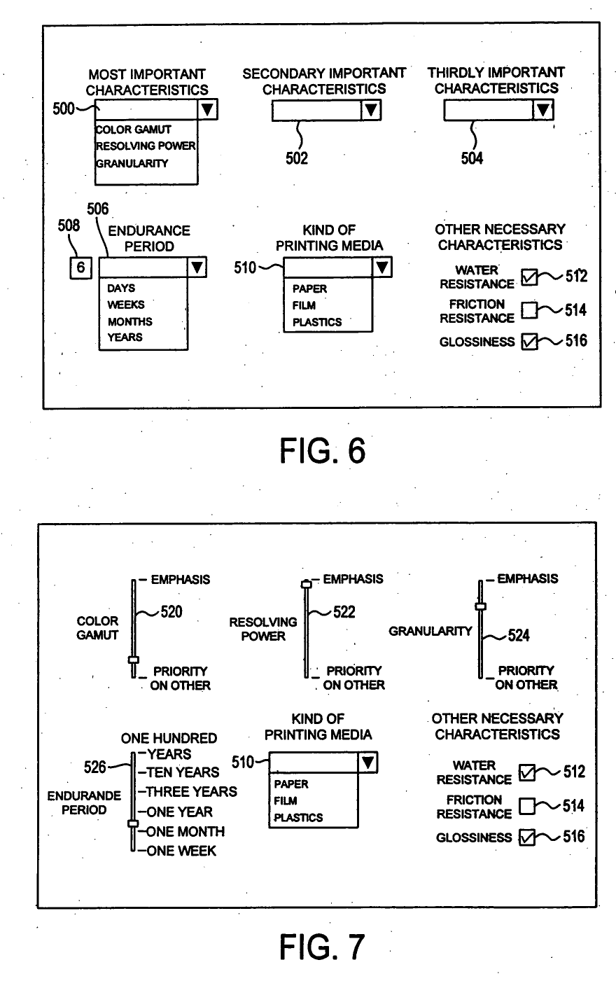

At step S104, the ink characteristics are input. The ink characteristics, after an input screen as shown in FIG. 6 is displayed on an operational panel 80, by following a guide of the input screen, are inputted by a user from the operational panel 80.

FIG. 6 is a diagram showing an input screen through which the ink characteristics are input.

In the input screen of FIG. 6, drop-down lists 500 through 504 that select the first through third important characteristics are displayed. In the drop-down lists 500 through 504, “color gamut”, “resolving power” and “granularity” are registered, and a user specifies priorities of the three characteristics with the drop-down lists 500 through 504. Furthermore, in the input screen of FIG. 6, a drop-down list 506 that selects a unit period of the endurance period and a text box 508 in which the endurance period is input are displayed. In the drop-down list 506, “days”, “weeks”, “months” and “years” are registered. The user specifies a desired endurance period with the drop-down list 506 and text box 508. In the input screen of FIG. 6, a drop-down list 510 that selects a kind of a printing medium is displayed. In the drop-down list 510, “paper”, “film” and “plastics” are registered, and the user specifies a desired kind from the drop-down list 510. Furthermore, in the input screen of FIG. 6, check boxes 512 through 516 by which the water resistance, friction resistance and glossiness are respectively specified are displayed. The user can specify desired ones of the water resistance, friction resistance and glossiness by checking the check boxes 512 through 516.

Without being restricted to the input screen of FIG. 6, by use of an input screen such as shown in FIG. 7, the ink characteristics may be input.

FIG. 7 is a diagram showing another input screen for inputting the ink characteristics.

In the input screen of FIG. 7, slide bars 520 through 524 that set the first through third important characteristics and a slide bar 526 that sets the endurance period are displayed. The user slides the slide bars 520 through 524 to specify the priorities of the color gamut, resolving power and granularity, and slides the slide bar 526 to specify the endurance period. Furthermore, in the input screen of FIG. 7, a drop-down list 510 and check boxes 512 through 516 are displayed. These are same as the input screen of FIG. 6.

Returning to FIG. 5, subsequently, the process proceeds to step S106, based on received printing data, a color gamut necessary for printing is calculated, followed by proceeding to step S108, ink cartridge information is read from the ink cartridge information registration table 400, and proceeds to step S110.

In step S110, based on the read ink cartridge information and inputted ink characteristics, whether the endurance period of ink in the ink cartridge is the specified endurance period or more is judged. When the endurance period of ink of the ink cartridge is found to be the specified endurance period or more (Yes), the process proceeds to step S112.

In step S112, based on the read ink cartridge information and inputted ink characteristics, whether the ink in the ink cartridge is printable on a printing medium of a specified kind or not is judged. When the ink in the ink cartridge is found printable on the printing medium of a specified kind (Yes), the process proceeds to step S114.

In step S114, based on the read ink cartridge information and inputted ink characteristics, when the water resistance, friction resistance or glossiness is specified, whether all of specified ones of the water resistance, friction resistance or glossiness are predetermined values (for instance, “5”) or more or not is judged. When all of the specified ones of the water resistance, friction resistance or glossiness are found to be predetermined values or more (Yes), the process proceeds to step S116.

In step S116, based on the read ink cartridge information and a corresponding color profile, a degree (hereinafter, referred to as color gamut multiplicity) at which a color gamut that the ink in the ink cartridge can represent covers the color gamut calculated in step S106 is calculated. Then, the process proceeds to step S118, and, based on the read ink cartridge information and inputted priorities, the calculated color gamut multiplicity and the resolving power and the granularity of the ink in the ink cartridge, respectively, are weighted and added to calculate a score, followed by proceeding to step S120.

In step S120, an ink cartridge relating to the read ink cartridge information is registered as a presentation candidate associated with the score in a memory 82. After proceeding to step S122, of all ink cartridges, whether all processes of steps S108 through S120 come to completion or not is judged. When it is judged that of all ink cartridges, the processes have come to completion (Yes), the process proceeds to step S124.

In step S124, whether one or more presentation candidates are registered in the memory unit 82 or not is judged. When one or more presentation candidates are found registered (Yes), the process proceeds to step S126, an ink cartridge highest in the score of the presentation candidates of the memory 82 is presented on the operation panel 84, and thereby a series of processes comes to completion and the process is returned to an initial step.

On the other hand, in step S124, when no presentation candidate is found registered (No) in the memory 82, the process proceeds to step S128 to display a message to the effect that there is no corresponding ink cartridge on the operational panel 84, and thereby a series of processes comes to completion and the process is returned to an initial step.

On the other hand, in step S122, when it is found that the process does not come to completion of all ink cartridges (No), the process proceeds to step S108.

On the other hand, in all when in step S114 any one of specified ones of the water resistance, friction resistance or glossiness of the ink in the ink cartridge is found less than the predetermined value (No) when in step S112 the ink in the ink cartridge is found imprintable on the printing medium of the specified kind (No), and when in step S110 the endurance period of the ink in the ink cartridge is found less than the specified endurance period (No), the process proceeds to step S122.

On the other hand, when, in step S100, the printing request is found not to have been received (No), the process stays at step S100 until the printing request is received.

Next, an operation of the embodiment will be described.

First, a user, in user's PC, sends the printing data together with the printing request to the ink jet printer 100.

In the ink jet printer 100, on receiving the printing data together with the printing request, through step S104, an input screen of FIG. 6 or 7 is displayed on an operational panel 80 to urge the input of the ink characteristics. Here, the user inputs desired ink characteristics.

Upon inputting the ink characteristics, through steps S106 through S114, based on the received printing data, a color gamut necessary for the printing is calculated, the ink cartridge information is read out, and, based on the read ink cartridge information and inputted ink characteristics, whether the ink in the ink cartridge has the specified ink characteristics or not is judged. As a result, when the ink is judged to have the specified ink characteristics, via steps S116 through S120, the color gamut multiplicity is calculated based on the read ink cartridge information and the corresponding color profile, the calculated color gamut multiplicity, resolving power and granularity, respectively, are weighted and added to calculate a score, followed by registering as a presentation candidate associated with the score.

The process of step S108 through S120 is carried out of all ink cartridges. Accordingly, among a plurality of ink cartridges, ones having the specified ink characteristics, after calculating scores, are registered as the presentation candidates. For instance, when the printing data require a color gamut of the sRGB and, in the ink jet printer 100, two kinds of 4-color ink cartridge and 6-color ink cartridge can be installed, of the 4-color ink cartridge, a degree at which a color gamut that 4-color inks of CMYK can represent covers a color gamut of the sRGB is calculated. In an example shown in FIG. 2, an area of a region where a color gamut 52 and a color gamut 54 overlap each other is calculated. Furthermore, of the 6-color ink cartridge, a degree at which a color gamut that 6-color inks of CMYK, red and blue can represent covers a color gamut of the sRGB is calculated. In an example shown in FIG. 2, an area of a region where a color gamut 56 and a color gamut 54 overlap each other is calculated.

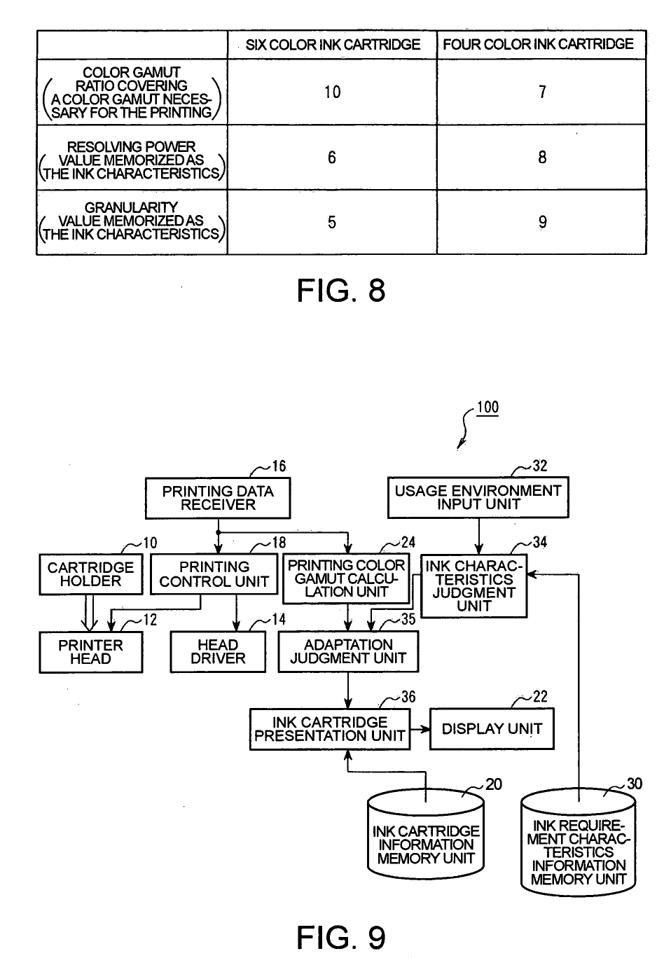

FIG. 8 is a table showing results obtained by calculating scores of the ink cartridges.

In the case of the 6-color ink cartridge being one that corresponds to “InkSet 1” in FIG. 4, when of the 6-color ink cartridge, as shown in FIG. 8, the color gamut multiplicity is calculated as “10”, the color gamut multiplicity, resolving power and granularity, respectively, become “10”, “6” and “5”. Furthermore, in the case of the 4-color ink cartridge being one that corresponds to “InkSet 2”, in FIG. 4, of the 4-color ink cartridge, since a degree at which the color gamut 52 covers the color gamut 54 is smaller than that at which the color gamut 56 covers the color gamut 54, when the color gamut multiplicity is assumed calculated at “7”, the color gamut multiplicity, resolving power and granularity, respectively, become “7”, “8” and “9”.

In descending order of the priority in the color gamut, resolving power and granularity, weight factors k1, k2 and k3 (for instance, k1=5, k2=2 and k3=1) are set. For instance, when the user specifies the priority in descending order of the color gamut, granularity and resolving power, a score of the 6-color ink cartridge becomes 10×k1+5×k2+6×k3=50+10+6=66, and a score of the 4-color ink cartridge becomes 7×k1+9×k2+8×k3=35+18+8=61. Accordingly, since the score of the 6-color ink cartridge is largest, via step S126, the 6-color ink cartridge is presented.

Furthermore, when the user specifies the priority in descending order of the resolving power, color gamut and granularity, a score of the 6-color ink cartridge becomes 6×k1+10×k2+5×k3=30+20+5=55, and a score of the 4-color ink cartridge becomes 8×k1+7×k2+9×k3=40+14+9=63. Accordingly, since the score of the 4-color ink cartridge is largest, via step S126, the 4-color ink cartridge is presented.

Next, the user installs the presented ink cartridge to a cartridge holder 10.

In the ink jet printer 100, when the ink cartridge is installed to the cartridge holder 10, the printing controller 18 controls the printer head 12 and the head controller 14 based on the received printing data. As a result, the ink in the ink cartridge is used to print.

When inks in all ink cartridges are judged to not have the specified ink characteristics, via step S128, a message to the effect that there is no corresponding ink cartridge is displayed.

Thus, in the embodiment, the ink cartridge information showing the ink characteristics for each of the ink cartridges is memorized. When the ink characteristics are inputted, based on the ink cartridge information, among a plurality of ink cartridges, one that adapts to the inputted ink characteristics is presented.

Thereby, more than ever, the proper characteristics corresponding to the usage environment of the printed matter can be more easily realized. Furthermore, since the only necessity is to exchange an ink cartridge, there is no need of disposing many cartridge holders 10 to the ink jet printer 100, and thereby a structure of the ink jet printer 100 does not become complicated.

Furthermore, in the embodiment, a color gamut necessary for printing is calculated based on the printing data, the color gamut multiplicity is calculated based on the ink cartridge information, the calculated color gamut multiplicity and a degree that adapts to the inputted ink characteristics are weighted and added to calculate a score, and an ink cartridge highest in the score is presented.

Thereby, since an ink cartridge adapted to a color gamut necessary for the printing can be presented, a color gamut necessary for the printing can be more easily realized.

Furthermore, in the embodiment, the ink cartridge information includes information showing the image quality characteristics, weather resistance, kinds of applicable printing media, performance of applicable ink jet printer 100, cost or environment adaptation characteristics.

Thereby, the image quality characteristics, weather resistance, kinds of applicable printing media, performance of applicable ink jet printer 100, cost or environment adaptation characteristics all necessary for the printing can be more easily realized.

In the first embodiment, the ink jet printer 100 corresponds to the printer of mode 14, 16, 20, 35 or 50; the cartridge holder 10 corresponds to the recording agent holding unit of mode 16; the printer controller 18 corresponds to the printing control unit of mode 16; and the ink cartridge information memory unit 20 and the memory unit 82 correspond to the recording agent information memory unit of mode 1, 5, 16, 22, 26, 37 or 41. Furthermore, the printing color gamut calculation unit 24 and step S106 correspond to the printing color gamut calculation unit of mode 5, step S106 corresponds to the calculating printing color gamut of mode 26 or 41, and the ink characteristics input unit 26 and step S104 correspond to the characteristics input unit of mode 1 or 16.

Still furthermore, in the first embodiment, step S104 corresponds to the inputting characteristics of the mode 22 or 37, the adaptation judgment unit 27 and steps S108 through S122 correspond to the adaptation judgment unit of mode 1, 5 or 16, and steps S108 through S122 correspond to the judging adaptation of mode 22, 26, 37 or 41. Furthermore, the ink cartridge presentation unit 28 and steps S124 and S126 correspond to the recording agent presentation unit of mode 1, 5, 15 or 16, and steps S124 and S126 correspond to the presenting recording agent of mode 22, 26, 36, 37, 41 or 51.

Furthermore, in the first embodiment, the ink corresponds to the recording agent of mode 1, 5, 15, 16, 22, 26, 36, 37, 41 or 51 and the ink cartridge information corresponds to the recording agent information of mode 1, 5, 14 through 16, 22, 26, 35 through 37, 41, 50 or 51.

Next, a second embodiment according to the invention will be described with reference to the drawings. FIGS. 9 through 13 show second embodiments of a printing support system, a printer and a printing support program, and a printing support method according to the invention.

The embodiment is one in which a printing support system, a printer and a printing support program, and a printing support method, according to the invention, as shown in FIG. 9, are applied to an ink jet printer 100 that is used through a network. A point that is different from the first embodiment is in that a user is asked to input a usage environment of a printed matter and the ink characteristics are judged based on the inputted usage environment. In what follows, only portions different from that of the first embodiment will be described, like portions as the first embodiment will be given like reference numerals and a description thereof will be omitted.

Firstly, a configuration of an ink jet printer 100 to which the invention is applied will be described with reference to FIG. 9.

FIG. 9 is a functional block diagram showing a configuration of the ink jet printer 100.

The ink jet printer 100, as shown in FIG. 9, is constituted including a cartridge holder 10, a printer head 12, a head driver 14, a printing data receiver 16, a printing controller 18, an ink cartridge information memory unit 20, a display unit 22 and a printing color gamut calculation unit 24.

The ink jet printer 100 is constituted further including an ink requirement characteristics information memory unit 30 for memorizing ink requirement characteristics information that shows the ink characteristics necessary for an ink for each of a plurality of different usage environments of a printed matter, a usage environment input unit 32 that inputs a usage environment of the printed matter, an ink characteristics judgment unit 34 that judges the ink characteristics necessary for the ink based on the usage environment inputted at the usage environment input unit 32, an adaptation judgment unit 35 that judges one that adapts to the ink characteristics judged at the ink characteristics judgment unit 34 among a plurality of ink cartridges, and an ink cartridge presentation unit 36 that presents the ink cartridge judged at the adaptation judgment unit 35.

The ink characteristics judgment unit 34 reads ink requirement characteristics information corresponding to the usage environment inputted at the usage environment input unit 32 from the ink requirement characteristics information memory unit 30, and, based on the read ink requirement characteristics information, judges the ink characteristics necessary for the ink.

The adaptation judgment unit 35 calculates, based on the ink cartridge information of the ink cartridge information memory unit 20, for each of the ink cartridges, a degree at which a color gamut that the ink can represent covers a color gamut calculated at the printing color gamut calculation unit 24, and a score by weighting and adding a degree that covers the calculated color gamut and a degree that adapts to the ink characteristics judged at the ink characteristics judgment unit 34.

The ink cartridge presentation unit 36 presents an ink cartridge having the largest score calculated at the adaptation judgment unit 35 on the display unit 22.

Next, a configuration of the ink jet printer 100 will be described.

The memory unit 82 stores an ink cartridge information registration table 400 and a plurality of color profiles.

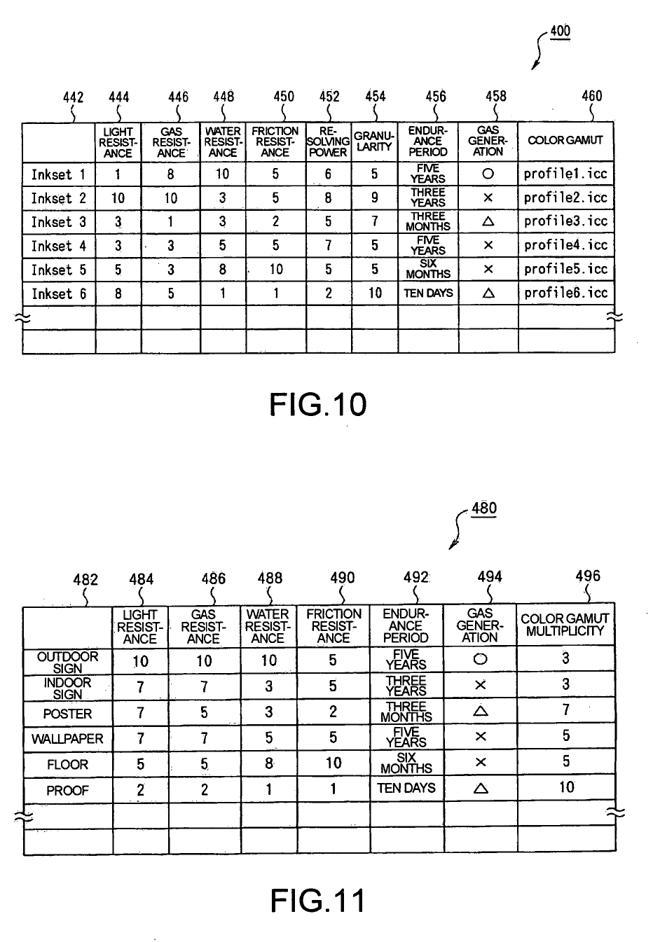

FIG. 10 is a diagram showing a data structure of the ink cartridge information registration table 400.

In the ink cartridge information registration table 400, as shown in FIG. 10, one record is registered for each of the ink cartridges. Each record is constituted including a field 442 where a name of the ink cartridge is registered, fields 444 through 456 in each of which the light resistance, gas resistance, water resistance, friction resistance, resolving power, granularity and endurance period are registered respectively, a field 458 in which a degree of occurrence of gas such as formaldehyde is registered, and a field 460 where a file name of the color profile is registered.

In an example shown in FIG. 10, in the record in a first step, “Inkset1” as a name of the ink cartridge, “1”, “8”, “10”, “5”, “6”, “5” and “5 years” as the light resistance, gas resistance, water resistance, friction resistance, resolving power, granularity and endurance period, “O” as the degree of occurrence of gas, and “profilel.icc” as a file name of the color profile are registered respectively. This shows of the ink cartridge “Inkset1” that the light resistance, gas resistance, water resistance, friction resistance, resolving power, granularity and endurance period, respectively, have above values, the degree of gas occurrence is high and a color gamut thereof is defined in the color profile “profile1.icc”. The light resistance and gas resistance, similarly to the water resistance, friction resistance, resolving power and granularity, are shown with numerical values in the range of substantially 1 to 10. Furthermore, the degree of occurrence of gas is divided into three grades, “O”, “Δ” and “x”, respectively, showing the highest, medium and lowest.

The memory unit 82 further stores an ink requirement characteristics information registration table 480 in which the ink requirement characteristics information is registered.

FIG. 11 is a diagram showing a data structure of the ink requirement characteristics information registration table 480.

In the ink requirement characteristics information registration table 480, as shown in FIG. 11, one record is registered for each the respective usage environments of the printed matters. Each record is constituted including a field 482 where a usage environment is registered, fields 484 through 492 in each of which the light resistance, gas resistance, water resistance, friction resistance and tolerance of the endurance period are registered respectively, a field 494 in which the tolerance of the degree of occurrence of gas is registered, and a field 496 where the tolerance of the color gamut multiplicity is registered.

In an example shown in FIG. 11, in the record in a first step, “Outdoor sign” as the usage environment, “10”, “10”, “10”, “5” and “5 years” as the light resistance, gas resistance, water resistance, friction resistance and tolerance of the endurance period, “O” as the tolerance of the occurrence of gas, and “3” as the tolerance of the color gamut multiplicity are registered respectively. This shows that of the usage environment “outdoor sign” the light resistance, gas resistance, water resistance, friction resistance, endurance period and the color gamut multiplicity, respectively, are necessary to be same or more than above values, and the gas occurrence may be high. The tolerance of the degree of occurrence of gas is divided into three grades, “O”, “Δ” and “x” that, respectively, show the lowest, medium and highest level. That shows that, when the tolerance of the degree of gas occurrence is “O”, an ink cartridge of any one of “O”˜“x” in the degree of gas occurrence can be selected, when the tolerance of gas occurrence is “Δ”, only ink cartridges of “Δ” or “O” can be selected, and when the tolerance of the degree of gas occurrence is “x”, only an ink cartridge of “O” in the degree of gas occurrence can be selected.

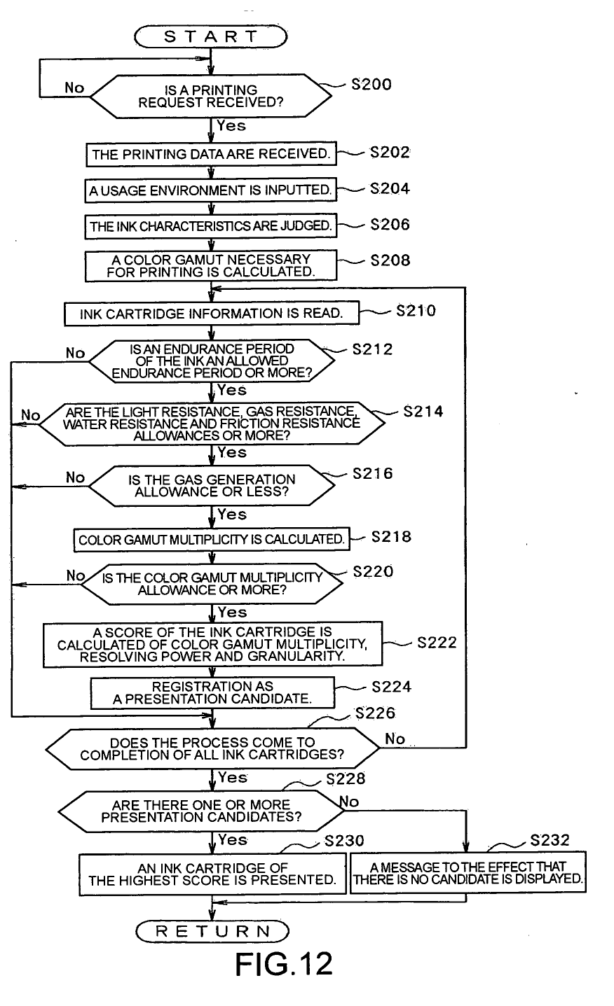

The CPU 70 executes, in place of the ink cartridge presentation process in FIG. 5, an ink cartridge presentation process shown in a flow chart of FIG. 12.

FIG. 12 is a flow chart showing an ink cartridge presentation process.

The ink cartridge presentation process, when executed in the CPU 70, as shown in FIG. 12, firstly proceeds to step S200.

In step S200, whether a printing request is received or not is judged. When the printing request is judged received (Yes), the process proceeds to step S202, printing data are received, followed by proceeding to step S204.

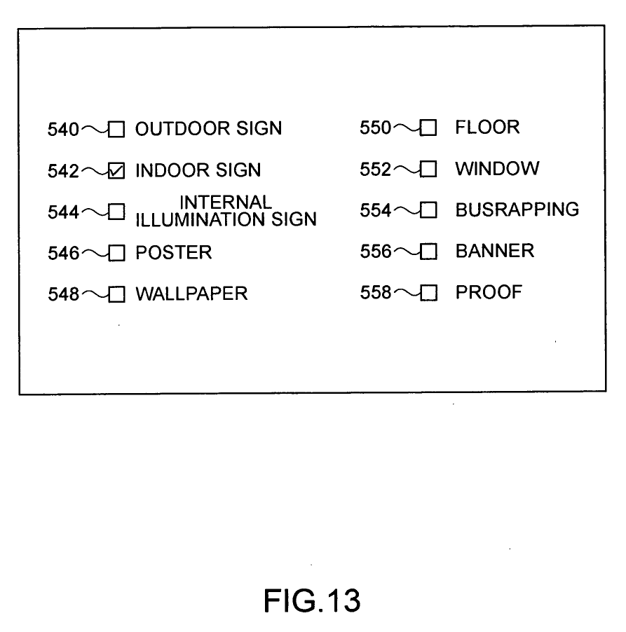

In step S204, a usage environment is input. After an input screen such as shown in FIG. 13 is displayed on an operational panel 80, following a guide of the input screen, the user inputs the usage environment from the operational panel 80.

FIG. 13 is a diagram showing an input screen where the usage environment is input.

In FIG. 13, check boxes 540 through 558 with which outdoor sign, indoor sign, indoor illumination sign, poster, wallpaper, floor, window, bus poster, banner and proof are respectively specified are displayed. The user can specify desired one among the usage environments by checking the check boxes 540 through 558.

Returning to FIG. 12, Next, the process proceeds to step S206, and, based on the inputted usage environment and the ink requirement characteristics information registration table 480, the ink characteristics necessary for the ink are judged. In the ink characteristics judgment, when any one of the usage environments is input in step S204, a corresponding record is read out of the ink requirement characteristics information registration table 480, and the read tolerance of the record is determined as the ink characteristics. Furthermore, when a plurality of usage environments is input in step S204, from the ink requirement characteristics information registration table 480, a plurality of corresponding records is read. For each field, one largest in the tolerances of the read records is determined as a representative tolerance of the field and the representative tolerance is determined as the ink characteristics.

Then, after proceeding to step S208, based on the received printing data, a color gamut necessary for the printing is calculated, after proceeding to step S210, ink cartridge information is read from the ink cartridge information registration table 400, followed by proceeding to step S212.

In step S212, based on the read ink cartridge information and the judged ink characteristics, whether the endurance period of the ink in the ink cartridge is a tolerated endurance period or more or not is judged. When the endurance period of the ink in the ink cartridge is judged to be the tolerated endurance period or more (Yes), the process proceeds to step S214.

In step S214, based on the read ink cartridge information and the judged ink characteristics, whether the light resistance, gas resistance, water resistance and friction resistance of the ink in the ink cartridge are tolerated levels or more or not is judged. When the light resistance, gas resistance, water resistance and friction resistance are judged tolerated levels or more (Yes), the process proceeds to step S216.

In step S216, based on the read ink cartridge information and the judged ink characteristics, whether the gas occurrence of the ink in the ink cartridge is a tolerated level or less or not is judged. When the gas occurrence of the ink in the ink cartridge is judged the tolerated level or less (Yes), the process proceeds to step S218.

In step S218, based on the read ink cartridge information and a corresponding color profile, the color gamut multiplicity is calculated, after proceeding to step S220, whether the calculated color gamut multiplicity is a tolerated level or more or not is judged. When the calculated color gamut multiplicity is judged a tolerated level or more (Yes), the process proceeds to step S222.

In step S222, based on the read ink cartridge information, calculated color gamut multiplicity, and the resolving power and the granularity of the ink in the ink cartridge, respectively, are weighted and added to calculate a score. After proceeding to step S224, an ink cartridge relating to the read ink cartridge information is registered in the memory 82 as a presentation candidate associated with the score, followed by proceeding to step S226.

In step S226, whether the process of steps S210 through S224 come to completion of all ink cartridges or not is judged. When it is judged that the process has come to completion of all ink cartridges (Yes), the step proceeds to S228.

In step S228, whether one or more presentation candidates are registered in the memory 82 or not is judged. When one or more presentation candidates are found registered (Yes), the step proceeds to S230, an ink cartridge having the highest score of the presentation candidates of the memory 82 is presented on an operational panel 84, followed by returning to an original process after a series of processes.

On the other hand, in step S228, when no presentation candidate is found registered (No) in the memory 82, the step proceeds to S232 to display, on the operational panel 84, a message to the effect that there is no corresponding ink cartridge, and thereby a series of processes comes to completion followed by returning to an original process.

On the other hand, in step S226, when it is found that the process does not come to completion of all ink cartridges (No), the step proceeds to S210.

On the other hand, in all when in step S220 the calculated color gamut multiplicity is judged less than the tolerance (No), when in step S216 the gas occurrence of the ink in the ink cartridge is judged the tolerance or more (No), when in step S214 the light resistance, gas resistance, water resistance and friction resistance of the ink in the ink cartridge are judged less than the tolerances (No), and when in step S212 the endurance period of the ink in the ink cartridge is judged less than a tolerated endurance period (No), the step proceeds to S226.

On the other hand, when, in step S200, the printing requirement is judged not to have been received (No), the process stays at step S200 until the printing request is received.

Next, an operation of the embodiment will be described.

First, the user, in a personal PC, transmits the printing data and a printing request to an ink jet printer 100.

In the ink jet printer 100, on receiving the printing data together with the printing request, through step S204, an input screen of FIG. 13 is displayed on an operational panel 80 to urge the input of the usage environment. Here, the user inputs desired one or more usage environments.

When the usage environment is input, via step S206, based on the inputted usage environment, the ink characteristics are judged. For instance, when as the usage environment, “indoor sign” is specified, the light resistance, gas resistance, water resistance, friction resistance, gas occurrence and color gamut multiplicity necessary for the ink, in FIG. 10, are determined as “7”, “7”, “3”, “5”, “three years”, “x” and “3”.

Next, via steps S208 through S216, a color gamut necessary for the printing is calculated based on the received printing data, the ink cartridge information is read, and, based on the read ink cartridge information and the judged ink characteristics, whether the ink in the ink cartridge has the tolerated ink characteristics or not is judged. In the above example, since a tolerated endurance period is “three years”, in FIG. 11, three ink cartridges of “InkSet1”, “InkSet2” and “InkSet4” correspond thereto. Furthermore, since tolerated light resistance, gas resistance, water resistance and friction resistance are “7”, “7”, “3” and “5”, among the three ink cartridges, the “InkSet2” corresponds thereto. Accordingly, in the example, the ink in the ink cartridge of the “InkSet2” is judged to have the tolerated ink characteristics.

When it is judged that the tolerated ink characteristics are possessed, via steps S218 and S220, based on the read ink cartridge information and the corresponding color profile, the color gamut multiplicity is calculated, and whether the calculated color gamut multiplicity is tolerance or more or not is judged. As a result, when the color gamut multiplicity is judged a tolerated level or more, via steps S222 and S224, the calculated color gamut multiplicity, and the resolving power and the granularity, respectively, are weighted and added to calculate a score, and the ink cartridge is registered as a presentation candidate associated with the score.

The process of steps S210 through S224 is applied to all ink cartridges. Accordingly, among a plurality of ink cartridges, one that has the tolerated ink characteristics and is a tolerated level or more in the color gamut multiplicity is, after calculating a score; registered as a presentation candidate. Then, via step S230, an ink cartridge highest in the score is presented. In the above example, an ink cartridge of the “InkSet2” is presented.

When all ink cartridges are judged that the ink does not have the tolerated ink characteristics or the color gamut multiplicity is less than the tolerance, via step S232, a message to the effect that the corresponding ink cartridge is not present is displayed.

Thus, in the embodiment, ink cartridge information showing the ink characteristics for each of the ink cartridges and ink requirement characteristics information showing the ink characteristics necessary for ink for each of usage environments of the printed matters are memorized. When the usage environment is input, based on the inputted usage environment and ink requirement characteristics information, the ink characteristics necessary for the ink are judged. Based on the ink cartridge information, among a plurality of ink cartridges, one that adapts to the judged ink characteristics is presented.

Thereby, more than ever, the characteristics suitable in accordance with the usage environment of the printed matter can be realized. Furthermore, since the only necessity is to exchange an ink cartridge, there is no need of disposing many cartridge holders 10 to the ink jet printer 100, and thereby a structure of the ink jet printer 100 does not become complicated.

In the second embodiment, the ink jet printer 100 corresponds to the printer of mode 14, 17, 20, 35 or 50; the cartridge holder 10 corresponds to the recording agent holding unit of mode 17; the printing controller 18 corresponds to the printing control unit of mode 17; and the ink cartridge information memory unit 20 and the memory 82 correspond to the recording agent information memory unit of mode 2, 5, 17, 23, 26, 38 or 41. Furthermore, the ink requirement characteristics information memory 30 and the memory 82 correspond to the recording agent requirement characteristics information memory unit of mode 3, 24 or 39, the printing color gamut calculation unit 24 and step S208 correspond to the printing color gamut calculation unit of mode 4 or 5, step S208 corresponds to the calculating printing color gamut of mode 25, 26, 40 or 41.

Still furthermore, in the second embodiment, the usage environment input unit 32 and step S204 correspond to the usage environment input unit of mode 2 or 17, step S204 corresponds to the inputting usage environment of mode 23 or 38, and the ink characteristics judgment unit 34 and step S206 correspond to the characteristics judgment unit of mode 2, 3 or 17. Furthermore, step S206 corresponds to the judging characteristics of mode 23, 24, 38 or 39, the adaptation judgment unit 35 and steps S210 through S226 correspond to the adaptation judgment unit of mode 2, 4, 5 or 17, and steps S210 through S226 correspond to the judging adaptation of mode 23, 25, 26, 38, 40 or 41.

Furthermore, in the second embodiment, the ink cartridge presentation unit 36 and steps S228 and S230 correspond to the recording agent presentation unit of mode 2, 4, 5, 15 or 17, and steps S228 and S230 correspond to the presenting recording agent of mode 23, 25, 26, 36, 38, 40, 41 or 51. Still furthermore, the ink corresponds to the recording agent of modes 2 through 5, 15, 17, 23 through 26, 36, 38 through 41 or 51, and the ink cartridge information corresponds to the recording agent information of mode 2, 5, 14, 15, 17, 23, 26, 35, 36, 38, 41, 50 or 51.

In the second embodiment, the ink requirement characteristics information corresponds to the recording agent requirement characteristics information of mode 3, 24 or 39.

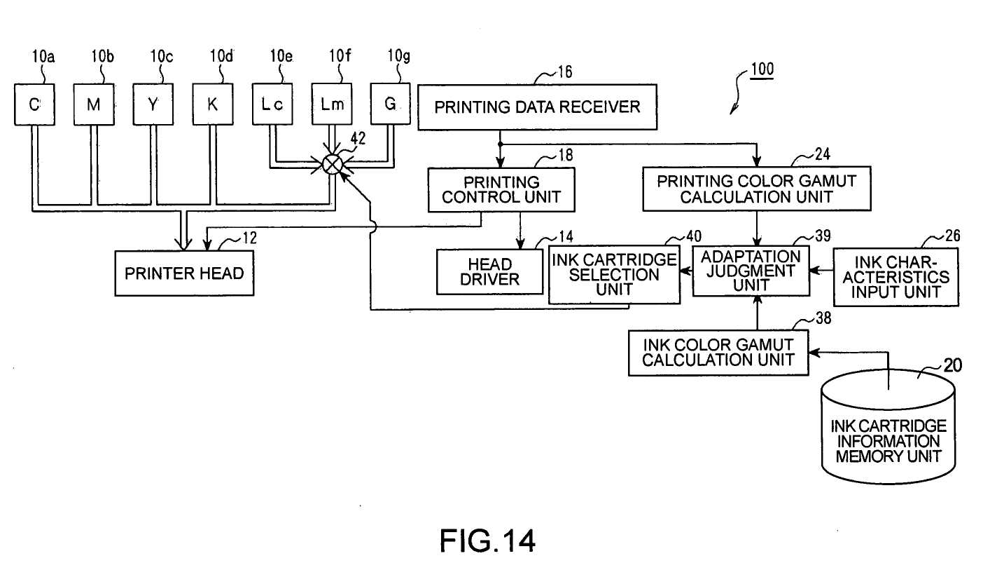

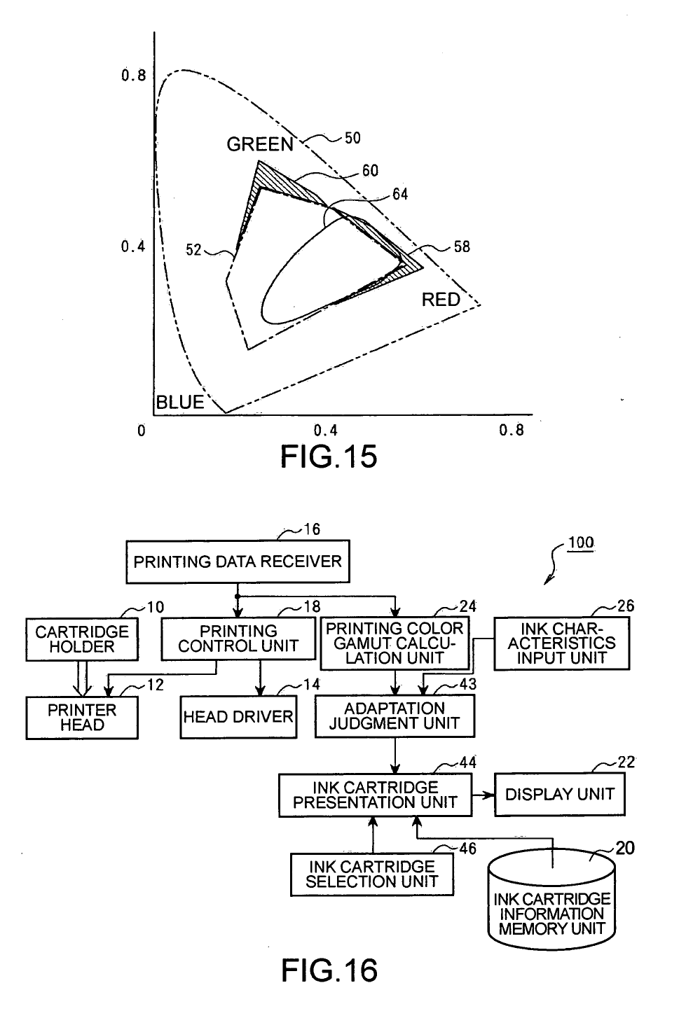

Next, a third embodiment according to the invention will be described with reference to the drawings. FIGS. 14 and 15 are diagrams showing the third embodiment of a printing support system, a printer and a printing support program, and a printing support method according to the invention.

In the embodiment, a printing support system, a printer and a printing support program, and a printing support method according to the invention, as shown in FIG. 14, are applied to an ink jet printer 100 that is used through a network. A point that is different from the first embodiment is in that among a plurality of ink cartridges any one is selected and the selected ink cartridge is used to print. In what follows, only portions different from the first embodiment will be described, like portions with the first embodiment will be given like reference numerals and a description thereof will be omitted.

First, a configuration of the ink jet printer 100 to which the invention is applied will be described with reference to FIG. 14.

FIG. 14 is a functional block diagram showing a configuration of the ink jet printer 100.

The ink jet printer 100, as shown in FIG. 14, is constituted including cartridge holders 10a through 10d capable of detachably attaching four color ink cartridges and cartridge holders 10e through 10g capable of detachably attaching ink cartridges of two color inks of light cyan (Lc) and light magenta (Lm) and gloss-ink (G). In what follows, ink cartridges installed to the cartridge holders 10e through 10g are respectively called “Lc ink cartridge”, “Lm ink cartridge” and “G ink cartridge”.

The ink jet printer 100 is constituted further including, other than a printer head 12, a head driver 14, a printing data receiver 16, a printing controller 18, an ink cartridge information memory 20, a printing color gamut calculator 24 and an ink characteristic input unit 26, a switching control valve 42 that connects one of ink flow paths from cartridge holders 10e through 10g to the printer head 12.

The printer head 12 connects the respective ink flow paths from the cartridge holders 10a through 10d and an ink flow path from the switching control valve 42, and thereby inks supplied from the cartridge holders 10a through 10d and the switching control valve 42 are respectively used to print on a printing medium.

In the ink cartridge information memory 20, ink cartridge information showing a color gamut that four color inks of CMYK corresponding to the four color ink cartridges can represent, ink cartridge information showing the ink characteristics of one color ink of light cyan (Lc) corresponding to a Lc ink cartridge, ink cartridge information showing the ink characteristics of one color ink of light magenta (Lm) corresponding to a Lm ink cartridge, and ink cartridge information showing the ink characteristics of gloss-ink (G) corresponding to a G ink cartridge are memorized.

The ink jet printer 100 is constituted further including an ink color gamut calculation unit 38 that calculates, based on the ink cartridge information of the ink cartridge information memory unit 20, a color gamut that inks in a plurality of ink cartridges can represent, an adaptation judgment unit 39 that judges, based on a calculation result at the ink color gamut calculation unit 38, among a plurality of ink cartridges, one that adapts to the ink characteristics inputted at the ink characteristics input unit 26, and an ink cartridge selection unit 40 that selects an ink cartridge judged at the adaptation judgment unit 39.

The ink color gamut calculation unit 38 calculates, for each of the Lc ink and the Lm ink, from a color gamut that one color ink can represent and a color gamut that the four color inks of CMYK can represent, a color gamut that five color inks can represent.

FIG. 15 is a graph showing a color gamut with an xy-chromaticity diagram.

In FIG. 15, an area 50 surrounded by a chain double-dashed line is a color gamut generally considered perceivable by a human being. Furthermore, an area 52 surrounded by a dashed line shows a color gamut that four color inks of CMYK can represent. Still furthermore, an area 58 shown with hatched lines on the right of the graph shows a color gamut that one color ink, Lc, can represent, and an area 60 shown with hatched lines in an upper portion of the graph shows a color gamut that one color ink, Lm, can represent.

As the color gamut calculated at the ink color gamut calculation unit 38, there are two of a color gamut that the five color inks of CMYKLc can represent and a color gamut that the five color inks of CMYKLm can represent. For instance, as to the five color inks of CMYKLc, when a color gamut 58 that one color ink, Lc, can represent is added to a color gamut 52 that the four color inks, CMYK, can represent, a color gamut that these five color inks can represent can be calculated.

The adaptation judgment unit 39, when the ink characteristics inputted at the ink characteristics input unit 26 are the glossiness, judges a G ink cartridge. When the ink characteristics inputted at the ink characteristics input unit 26 are not the glossiness, a degree at which a color gamut that the five color inks, CMYKLc, can represent covers the color gamut calculated at the printing color gamut calculation unit 24 (hereinafter, referred to as color gamut multiplicity Lc) and a degree at which a color gamut that the five color inks, CMYKLm, can represent covers the color gamut calculated at the printing color gamut calculation unit 24 (hereinafter, referred to as color gamut multiplicity Lm) are, respectively, calculated. A larger one of the calculated color gamut multiplicities Lc and Lm and the degree that adapts to the ink characteristics inputted at the ink characteristics input unit 26, respectively, are weighted and added to calculate a score.

The ink cartridge selection unit 40 selects, among the Lc ink cartridge and the Lm ink cartridge, the one with the largest score calculated at the adaptation judgment 39.

The switching control valve 42 connects an ink flow path of one corresponding to an ink cartridge selected at the ink cartridge selection unit 40 among cartridge holders 10e through 10g to the printer head 12.

Next, an operation of the embodiment will be described.

First, a user, in user's PC, sends the printing data to the ink jet printer 100.

In the ink jet printer 100, on receiving the printing data at the printing data receiver 16, the printing color gamut calculation unit 24 calculates, based on the received printing data, a color gamut necessary for the printing. Furthermore, the ink color gamut calculation unit 38 calculates, for each of Lc and Lm inks, from a color gamut that one color ink thereof can represent and a color gamut that the four color inks of CYMK can represent, a color gamut that can be represented with the five color inks is calculated.

Then, when a user inputs the glossiness as necessary characteristics from the ink characteristics input unit 26, the adaptation judgment unit 39 and the ink cartridge selection unit 40 select the G ink cartridge.

When the G ink cartridge is selected, the switching control valve 42 connects an ink flow path from the cartridge holder 10g to the printer head 12. The printing control unit 18 controls, based on the received printing data, the printer head 12 and the head driver 14. As a result, the four color inks of CMYK and the gloss-ink are used to print.

On the other hand, when the user inputs, as the characteristics necessary for the printing, the ink characteristics other than the glossiness from the ink characteristics input unit 26, the adaptation judgment unit 39 calculates the color gamut multiplicities Lc and Lm based on the results calculated at the ink color gamut calculation unit 38, and a score by weighting and adding larger one of the calculated color gamut multiplicities Lc and Lm and a degree that adapts to the inputted ink characteristics. For instance, in FIG. 15, a color gamut necessary for the printing is assumed to be a region 64 surrounded by a solid line. In this case, when the color gamut 64 necessary for the printing is compared with a color gamut (52+58) that the five color inks of CMYKLc can represent and a color gamut (52+60) that the five color inks of CMYKLm can represent, respectively, the color gamut (52+58) is larger in the degree that covers the color gamut 64. Accordingly, the color gamut multiplicity Lc and a degree that adapts to the inputted ink characteristics are, respectively, weighted and added to calculate a score. Thereafter, the ink cartridge selection unit 40 selects one largest in the score among the Lc ink cartridge and the Lm ink cartridge. For instance, when the score of the Lc ink cartridge is larger, the Lc ink cartridge is selected.

When the Lc ink cartridge is selected, the switching control valve 42 connects an ink flow path from the cartridge holder 10e to the printer head 12. The printing controller 18 controls the printer head 12 and the head driver 14 based on the received printing data. As a result, the five color inks of CMYKLc are used to print.

Thus, in the embodiment, the ink cartridge information showing the ink characteristics for each of the ink cartridges is memorized. When the ink characteristics are inputted, based on the ink cartridge information, among a plurality of ink cartridges, one that adapts to the inputted ink characteristics is presented.

Thereby, the characteristics most suitable in accordance with the usage environment of the printed matter become realizable more easily.

Furthermore, in the embodiment, the color gamut necessary for the printing is calculated based on the printing data, the color gamut multiplicity is calculated based on the ink cartridge information, the calculated color gamut multiplicity and a degree that adapts to the inputted ink characteristics, respectively, are weighted and added to calculate a score, and an ink cartridge having the largest score is selected.

Thereby, since an ink cartridge that adapts to a color gamut necessary for the printing can be selected, a color gamut necessary for the printing can be more easily realized.

Furthermore, in the embodiment, for each of Lc and Lm inks, from a color gamut that one color ink thereof can represent and a color gamut that the four color inks of CMYK can represent, a color gamut that the five color inks can represent is calculated.

Thereby, since a color gamut when a plurality of ink cartridges is combined can be calculated, a plurality of ink cartridges adapted to a color gamut necessary for the printing can be selected. Accordingly, a color gamut necessary for the printing can be more easily realized.

In the third embodiment, the ink jet printer 100 corresponds to the printer of mode 14, 18, 20, 35 or 50; the cartridge holder 10a through 10g corresponds to the recording agent holding unit of mode 18; and the printing controller 18 corresponds to the printing control unit of mode 18. Furthermore, the ink cartridge information memory unit 20 corresponds to the recording agent information memory unit of mode 9, 12, 13, 18, 30, 33, 34, 45, 48 or 49; the printing color gamut calculation unit 24 correspond the printing color gamut calculation unit of mode 12 or 13; and the ink characteristics input unit 26 corresponds to the characteristics input unit of mode 9 or 18.

Furthermore, in the third embodiment, the ink color gamut calculation unit 38 corresponds to the recording agent color gamut calculation unit of mode 13; the adaptation judgment unit 39 corresponds to the adaptation judgment unit of mode 9, 12, 13, 18, 30 or 45; and the ink cartridge selection unit 40 corresponds to the recording agent selection unit of mode 9, 12, 13 or 18. Still furthermore, the ink corresponds to the recording agent of mode 9, 12, 13, 15, 18, 30, 33, 34, 36, 45, 48, 49 or 51; and the ink cartridge information corresponds to the recording agent information of mode 9, 12 through 15, 18, 30, 33 through 36, 45, or 48 through 51.

In the first embodiment, the calculated color gamut multiplicity and a degree that adapts to the inputted ink characteristics are, respectively, weighted and added to calculate a score, and an ink cartridge largest in the score is presented. Without being restricted to this, a score is calculated from the calculated color gamut multiplicity and a degree that adapts to the inputted ink characteristics, and in descending order of the calculated scores the ink cartridges can be presented. A specific example is shown in, for instance, FIG. 16.

FIG. 16 is a functional block diagram showing a configuration of an ink jet printer 100.

The ink jet printer 100 is constituted, as shown in FIG. 16, including a cartridge holder 10, a printer head 12, a head driver 14, a printing data receiver 16, a printing control unit 18, an ink cartridge information memory unit 20, a display unit 22, a printing color gamut calculation unit 24 and an ink characteristics input unit 26.

The ink jet printer 100 is constituted further including an adaptation judgment unit 43 that judges, based on results calculated at the printing color gamut calculation unit 24 and the ink cartridge information of the ink cartridge information memory unit 20, a plurality of ink cartridges that adapt to the ink characteristics inputted at the ink characteristics input unit 26; an ink cartridge presentation unit 44 that presents the plurality of ink cartridges judged at the adaptation judgment unit 43 on a display unit 22; and an ink cartridge selection unit 46 that selects and inputs any one from the ink cartridges presented at the ink cartridge presentation unit 44.

The adaptation judgment unit 43 calculates, based on the ink cartridge information of the ink cartridge information memory unit 20, for each of the ink cartridges, a degree that a color gamut that the ink can represent covers a color gamut calculated at the printing color gamut calculation unit 24, and a score by weighting and adding the degree of covering the calculated color gamut and a degree that adapts to the ink characteristics inputted at the ink characteristics input unit 26, respectively.

The ink cartridge presentation unit 44 presents the ink cartridges in descending order of the scores calculated at the adaptation judgment unit 43.

Thereby, an ink cartridge that adapts to the color gamut necessary for the printing can be preferentially presented; accordingly, the color gamut necessary for the printing becomes more easily realizable.

The configuration of FIG. 16 can be similarly applied as well to the second and third embodiments. That is, when it is applied to the second embodiment, the color gamut multiplicity and a degree that adapts to the judged ink characteristics, respectively, are weighted and added to calculate a score, and the ink cartridges are presented in descending order of the scores. Furthermore, when it is applied to the third embodiment, the color gamut multiplicity and a degree that adapts to the inputted ink characteristics, respectively, are weighted and added to calculate a score, the ink cartridges are presented in descending order of the scores, and an ink cartridge selected by the ink cartridge selection unit 46 is used to print.

In this case, the ink cartridge information memory unit 20 corresponds to the recording agent information memory unit of mode 7, 8, 28, 29, 43 or 44; the printing color gamut calculation unit 24 corresponds to the printing color gamut calculation unit of mode 7 or 8; and the adaptation judgment unit 43 corresponds to the adaptation judgment unit of mode 7 or 8. Furthermore, the ink cartridge presentation unit 44 corresponds to the recording agent presentation unit of mode 7 or 8.

Furthermore, in the first and second embodiments, an ink of presented one ink cartridge is used to print. Without being restricted thereto, like the third embodiment, inks of a plurality of ink cartridges may be used to print. For instance, when four color ink cartridges and any one of Lc and Lm ink cartridges are utilized, an ink color gamut calculation unit that calculates, for each of inks of Lc and Lm, from a color gamut that one color ink thereof can represent and a color gamut that four color inks of CMYK can represent, a color gamut that five color inks can represent is disposed. Based on the results calculated at the ink color gamut calculation unit, a combination of ink cartridges having inks that can represent a color gamut largest in a degree that covers the calculated color gamut is presented.

Thereby, since a color gamut when a plurality of ink cartridges is combined can be calculated, a plurality of ink cartridges adapted to the color gamut necessary for the printing can be selected. Accordingly, the color gamut necessary for the printing can be further more easily realized.

Such a configuration can be applied similarly to a configuration of FIG. 16 as well.

In this case, the ink cartridge information memory unit 20 corresponds to the recording agent information memory unit of mode 6, 27 or 42; the printing color gamut calculation unit 24 corresponds to the printing color gamut calculation unit of mode 6; the adaptation judgment units 27 and 35 correspond to the adaptation judgment unit of mode 6; and the ink cartridge presentation units 28 and 36 correspond to the recording agent presentation unit of mode 6. Furthermore, the ink color gamut calculation unit corresponds to the recording agent color gamut calculation unit of mode 6.

In the third embodiment, the ink characteristics are inputted and based on the ink cartridge information one that adapts to the inputted ink characteristics is selected from a plurality of ink cartridges. However, without being restricted thereto, like the second embodiment, the third embodiment can be configured in such a way that the usage environment is inputted, based on the inputted usage environment the ink characteristics necessary for the ink are judged, and based on the ink cartridge information one that adapts to the judged ink characteristics is selected from the plurality of ink cartridges.

Furthermore, in the first embodiment, after a user inputs all the ink characteristics, an ink cartridge is presented. However, without being restricted thereto, the embodiment can be configured in such a manner that each time when the user inputs each item of the ink characteristics, ink cartridges that have so far inputted ink characteristics are presented, and from the presented ink cartridges the user selects, or the ink characteristics are inputted until one ink cartridge is left. Such a configuration can be similarly applied to the second embodiment when the usage environment is input.

Furthermore, in the first through third embodiments, cases where colored inks are used are described. However, without being restricted thereto, colorless and transparent ink having the predetermined ink characteristics can be used as well.

Thereby, even without disposing an excessive ink cartridge holder, when multi-color inks are necessary for representing a color gamut of the printing data, the multi-color printing is carried out. When a small number of inks suffice, a transparent ink can be automatically selected to use. Alternatively, even when multi-color inks are necessary to represent a color gamut of the printing data, after the ink cartridge presentation unit or the like notifies the user of that effect, the user can be asked to select whether in preference to a color gamut multi-color inks are used to print, or by narrowing the color gamut a transparent ink is used.

Furthermore, in the second embodiment, in order to present the ink cartridges with the usage environment associated with the ink characteristics, and the ink characteristics associated with the ink cartridge, respectively, the ink cartridge that adapts to the ink characteristics is presented. However, without being restricted thereto, when the ink characteristics are changed to the usage environment or a selectable ink cartridge is altered, the respective associations can be independently altered. Thereby, an alteration operation becomes simpler, even after the alteration the ink cartridge can be properly selected. It is possible to configure in such a manner that after the usage environment is inputted, a proper ink cartridge is searched and selected. However, in this case, when the usage environment and ink cartridge are associated with each other, an operation of matching the ink characteristics and the characteristics of the ink cartridge becomes necessary.

Furthermore, in the first and third embodiments, when the water resistance, friction resistance or glossiness is specified, whether all specified ones among the water resistance, friction resistance or glossiness have the predetermined value or more or not is judged. Without being restricted thereto, the water resistance, friction resistance or glossiness as well, together with the color gamut multiplicity, resolving power and granularity may be weighted and added to calculate a score.

Still furthermore, in the first and second embodiments, the calculated color gamut multiplicity and the degree that adapts to the inputted ink characteristics, respectively, are weighted and added to calculate a score, and an ink cartridge having the largest score is presented. However, without being restricted thereto, an ink cartridge can be presented considering a remainder amount of the ink. Specifically, an ink remainder information memory unit for memorizing ink remainder information that exhibits a remaining amount of the ink for each of the ink cartridges is disposed, and, based on the ink remainder information of the ink remainder information memory unit, the calculated color gamut multiplicity, the ink remainder and the degree that adapts to the inputted ink characteristics, respectively, are weighted and added to calculate a score, and an ink cartridge having the largest score is presented.

Thereby, an ink cartridge that is much in the ink remainder is expected preferentially used; accordingly, the likelihood in that some of ink cartridges are preferentially used can be reduced.

Such a configuration can be applied as well to the third embodiment and a configuration shown in FIG. 16. In the case of the third embodiment, the calculated color gamut multiplicity, the degree that adapts to the inputted ink characteristics and the ink remainder, respectively, are weighted and added to calculate a score, and an ink cartridge having the largest score is selected. In the case of FIG. 16, based on the ink remainder information of the ink remainder information memory unit, the color gamut multiplicity, the degree that adapts to the ink characteristics and the ink remainder, respectively, are weighted and added to calculate a score, and the ink cartridges are presented in descending order of the scores.

Other than this, as a narrowing method of the ink cartridges, for instance, any one of the ink cartridges is presented in accordance with a predetermined rule. For instance, when usable ink cartridge is CMYKRB (red, blue) or CMYKLcLm and a color gamut that four color inks of CMYK can represent is sufficient for a color gamut necessary for the printing, according to the rule, the ink cartridge of CMYKLcLm is selected (owing to a program this may be carried out or, separately from the program, a rule table may be possessed).

Furthermore, in the first through third embodiments, a conception of comparing two-dimensionally on an xy-chromaticity diagram a color gamut that an ink can represent and a color gamut necessary for the printing is described. Without being restricted thereto, in actuality, in a three-dimensional color space such as a CIE L*a*b* color system, both color gamuts are desirably compared.

Furthermore, in the third embodiment, the switching control valve 42 switches an ink flow path. However, without being restricted thereto, for instance, an ink cartridge may be switched with a robot hand.

Still furthermore, in the first and second embodiments, the ink cartridge is displayed on the display unit 22. However, without being restricted thereto, for instance, via a printer driver, it can be displayed on a display of the PC. Furthermore, it is possible to ask a user to judge selection after specifically displaying a chromaticity diagram such as shown in FIG. 2.

In the first through third embodiments, the color gamut multiplicity is calculated based on the ink cartridge information showing a color gamut that the ink can represent. However, without being restricted thereto, without using the ink cartridge information, the color gamut multiplicity may be calculated. Specifically, based on the ink cartridge information showing the ink characteristics (spectral reflectance characteristics) other than the color gamut, for each of the ink cartridges, a color gamut that the ink can represent is calculated, and based on results thereof the color gamut multiplicity is calculated.

Furthermore, in the first and third embodiments, a degree (color gamut multiplicity) at which a color gamut that an ink in the ink cartridge can represent covers a color gamut necessary for the printing is calculated, and the ink cartridges larger in the calculated color gamut multiplicity are preferentially presented or selected. However, without being restricted thereto, of a color gamut necessary for the printing, a degree (color gamut non-multiplicity) of a region that does not overlap with a color gamut that ink in the ink cartridge can represent is calculated, and the ink cartridges smaller in the calculated color gamut non-multiplicity are preferentially presented or selected.

In FIG. 15, when a color gamut 64 necessary for the printing is compared with a color gamut (52+58) that five color inks of CMYKLc can represent and a color gamut (52+60) that five color inks of CMYKLm can represent respectively, the color gamut (52+58) is smaller in an area of a region that does not overlap with the color gamut of the color gamut 64. Accordingly, the color gamut non-multiplicity and a degree that adapts to the inputted ink characteristics are respectively weighted and added to calculate a score. Then, one smallest in the score between the Lc ink cartridge and the Lm ink cartridge is selected.

Furthermore, in the first through third embodiments, a printing support system, a printer and a printing support program, and a printing support method according to the invention are applied to the ink jet printer 100. However, without being restricted thereto, within a range that does not deviate from a gist of the invention, these can be applied to all cases.

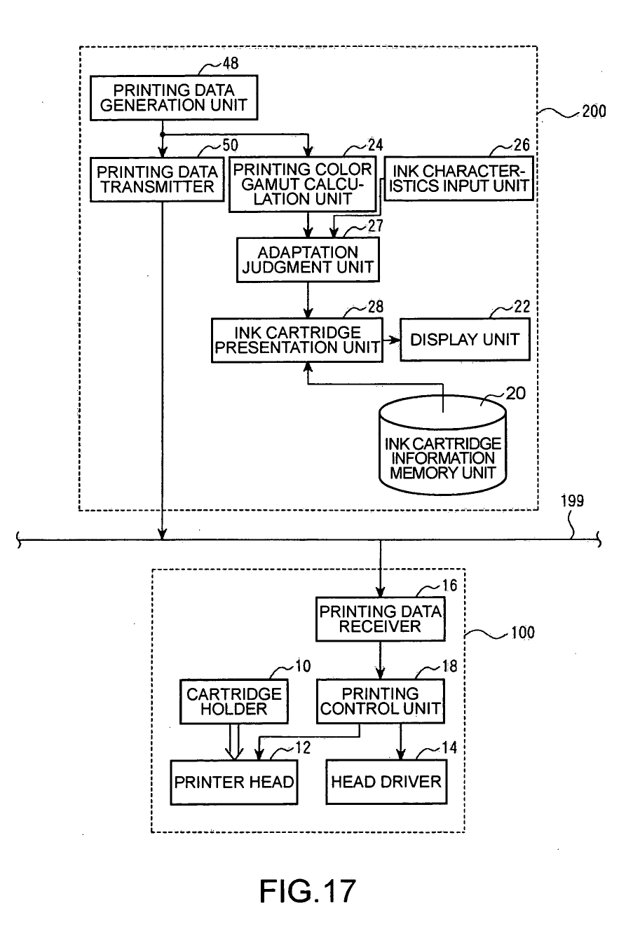

Firstly, without being restricted to configuring with an ink jet printer 100 simple body, a network system in which a PC and an ink jet printer 100 are communicatably connected can be formed. Specifically, for instance, a configuration can be formed like FIG. 17.

FIG. 17 is a functional block diagram showing a configuration of a network system to which the invention is applied.

To a network 199, as shown in FIG. 17, an ink jet printer 100 and a PC200 that a user can utilize are connected.

The PC200 is constituted including a printing data generation unit 48 that generates printing data, a printing data transmitter 49 that transmits the printing data generated at the printing data generation unit 48 to the ink jet printer 100, a printing color gamut calculation unit 24 that, based on the printing data generated at the printing data generation unit 48, calculates a color gamut necessary for the printing.

The PC200 is constituted further including an ink cartridge information memory 20, a display unit 22, an ink characteristics input unit 26, an adaptation judgment unit 27 and an ink cartridge presentation unit 28.

The ink jet printer 100 is constituted including a cartridge holder 10, a printer head 12, a head driver 14, a printing data receiver 16 and a printing controller 18.

The configuration of FIG. 17 can be similarly applied to the second and third embodiments and a configuration of FIG. 16.

Secondly, without being restricted to the ink jet printer 100, the configuration of FIG. 17 can be applied as well to a laser printer, a large-scale printing machine such as an offset printing machine, and other printers.

Thirdly, without being restricted to an ink jet printer 100 that is utilized via a network, the configuration of FIG. 17 can be applied as well to a printer connected via an exclusive printer cable with a PC.

What is claimed is:

1. A printing support system that supports using a recording agent to print, comprising:
a recording agent information memory unit that stores recording agent information of characteristics of a plurality of the recording agents;
a characteristics input unit that inputs characteristics of a desired recording agent;
an adaptation judgment unit that selects, based on the recording agent information in the recording agent information memory unit, among the plurality of recording agents, one recording agent that corresponds to the characteristics inputted at the characteristics input unit; and
a recording agent presentation unit that presents the one recording agent that is selected at the adaptation judgment unit.

2. A printing support system that supports using a recording agent to print, comprising:
a recording agent information memory unit that stores recording agent information of characteristics of a plurality of the recording agents;
a usage environment input unit for inputting a usage environment of a printed matter;
a characteristics judgment unit that determines, based on the usage environment inputted at the usage environment input unit, the characteristics necessary for a desired recording agent;
an adaptation judgment unit that selects, based on the recording agent information in the recording agent information memory unit, among the plurality of recording agents, one recording agent that corresponds to the characteristics determined at the characteristics judgment unit; and
a recording agent presentation unit that presents the one recording agent that is selected at the adaptation judgment unit.

3. The printing support system according to claim 2, further comprising:
a recording agent requirement characteristics information memory unit that stores recording agent requirement characteristics information of the characteristics necessary for the recording agent for each of the usage environments of the printed matter;
wherein the characteristics judgment unit determines, based on the recording agent requirement characteristics information of the recording agent requirement characteristics information memory unit, the characteristics necessary for the recording agent.

4. The printing support system according to claim 1, further comprising:
a printing color gamut calculation unit that calculates a color gamut necessary for printing based on printing data;
wherein the adaptation judgment unit calculates, based on a color gamut that the recording agent can represent and a color gamut calculated at the printing color gamut calculation unit, an evaluation value; and
the recording agent presentation unit presents, based on the evaluation value calculated at the adaptation judgment unit, a recording agent or a combination of recording agents.

5. The printing support system according to claim 1, further comprising:
a printing color gamut calculation unit that calculates a color gamut necessary for printing based on the printing data;
wherein the adaptation judgment unit calculates, based on the recording agent information of the recording agent information memory unit, a degree at which a color gamut that the recording agent can represent covers the color gamut calculated at the printing color gamut calculation unit, and, from a degree that covers the calculated color gamut and a degree that corresponds to the inputted or judged characteristics, an evaluation value; and
the recording agent presentation unit presents a recording agent or a combination of recording agents having a largest evaluation value calculated at the adaptation judgment unit.

6. The printing support system according to claim 5, further comprising:
a recording agent color gamut calculation unit that calculates, based on the recording agent information of the recording agent information memory unit, from a color gamut that each of a plurality of the recording agents can represent, a color gamut that a mixed color of the recording agents can represent;
wherein the adaptation judgment unit calculates, based on a result calculated at the recording agent color gamut calculation unit, a degree at which the color gamut that the recording agent can represent covers a color gamut calculated at the printing color gamut calculation unit, and, from a degree of covering the calculated color gamut and a degree of corresponding to the inputted or judged characteristics, an evaluation value; and
the recording agent presentation unit presents a recording agent or a combination of recording agents having a largest evaluation value calculated at the adaptation judgment unit.

7. The printing support system according to claim 1, further comprising:
a printing color gamut calculation unit that calculates, based on the printing data, a color gamut necessary for the printing;
wherein the adaptation judgment unit calculates, based on the recording agent information of the recording agent information memory unit, a degree at which a color gamut that the recording agent can represent covers the color gamut calculated at the printing color gamut calculation unit, and, from a degree that covers the calculated color gamut and a degree that corresponds to the inputted or judged characteristics, an evaluation value; and
the recording agent presentation unit presents the recording agents or combinations of recording agents in descending order of the evaluation values calculated at the adaptation judgment unit.

8. The printing support system according to claim 7, further comprising:
a recording agent color gamut calculation unit that calculates, based on recording agent information of the recording agent information memory unit, from a color gamut that each of a plurality of the recording agents can represent, a color gamut that a mixed color of the recording agents can represent;
wherein the adaptation judgment unit calculates, based on the result calculated at the recording agent color gamut calculation unit, a degree at which the color gamut that the recording agent can represent covers a color gamut calculated at the printing color gamut calculation unit, and, from a degree of covering the calculated color gamut and a degree of corresponding to the inputted or judged characteristics, an evaluation value; and
the recording agent presentation unit presents the recording agents or combinations of recording agents in descending order of the evaluation values calculated at the adaptation judgment unit.

9. A printing support system that supports using a recording agent to print, comprising:
a recording agent information memory unit that stores recording agent information of characteristics of a plurality of the recording agents;
a characteristics input unit that inputs the characteristics of a desired recording agent;
an adaptation judgment unit that determines, based on the recording agent information of the recording agent information memory unit, among the plurality of recording agents, one recording agent that corresponds to the characteristics inputted at the characteristics input unit; and
a recording agent selection unit that selects the one recording agent that is determined at the adaptation judgment unit among the plurality of recording agents.

10. A printing support system that supports using a recording agent to print, comprising:
a recording agent information memory unit that stores recording agent information of characteristics of a plurality of the recording agents;
a usage environment input unit that inputs a usage environment of a printed matter;
a characteristics judgment unit that determines, based on the usage environment inputted at the usage environment input unit, the characteristics necessary for a desired recording agent;
an adaptation judgment unit that determines, based on the recording agent information of the recording agent information memory unit, among the plurality of the recording agents, one recording agent that corresponds to the characteristics determined at the characteristics judgment unit; and
a recording agent selection unit that selects the one recording agent that is determined at the adaptation judgment unit among the plurality of recording agents.

11. The printing support system according to claim 1,
wherein the recording agent information includes at least one of: information showing the image quality characteristics; weather resistance characteristics;
applicable printing media; performances of applicable printers; costs; and environment adaptation characteristics.

12. The printing support system according to claim 1, wherein:
the recording agent information includes identification information of the recording agent; and
the recording agent presentation unit presents the identification information of the recording agent.

13. A printer that includes a recording agent holding unit that holds a recording agent and a printing control unit that carries out printing control based on printing data, and uses the recording agent held at the recording agent holding unit to print, comprising:
a recording agent information memory unit that stores recording agent information of characteristics of a plurality of recording agents;
a characteristics input unit that inputs the characteristics of a desired recording agent;
an adaptation judgment unit that determines, based on the recording agent information in the recording agent information memory unit, among the plurality of recording agents, one recording agent that corresponds to the characteristics inputted at the characteristics input unit; and
a recording agent presentation unit that presents the one recording agent determined at the adaptation judgment unit.

14. A printer that includes a recording agent holding unit that holds a recording agent and a printing control unit that carries out printing control based on printing data, and uses the recording agent held at the recording agent holding unit to print, comprising:
a recording agent information memory unit that stores recording agent information of characteristics of a plurality of recording agents;
a usage environment input unit that inputs a usage environment of a printed matter;
a characteristics judgment unit that determines, based on the usage environment inputted at the usage environment input unit, the characteristics necessary for a desired recording-agent;
an adaptation judgment unit that determines, based on the recording agent information in the recording agent information memory unit, among the plurality of recording agents, one recording agent that corresponds to the characteristics determined at the characteristics judgment unit; and
a recording agent presentation unit that presents the one recording agent determined at the adaptation judgment unit.

15. A printer that includes a recording agent holding unit that holds a recording agent and a printing control unit that carries out printing control based on printing data, and uses the recording agent held at the recording agent holding unit to print, comprising:
a recording agent information memory unit that stores recording agent information of characteristics of a plurality of recording agents;
a characteristics input unit that inputs the characteristics of the recording agent;
an adaptation judgment unit that determines, based on the recording agent information of the recording agent information memory unit, among the plurality of recording agents, one recording agent that corresponds to the characteristics inputted at the characteristics input unit; and
a recording agent selection unit that selects, among the plurality of recording agents, the one recording agent that is determined at the adaptation judgment unit.

16. A printer that includes a recording agent holding unit that holds a recording agent and a printing control unit that carries out printing control based on printing data, and uses the recording agent held at the recording agent holding unit to print, comprising:
a recording agent information memory unit that stores recording agent information of characteristics of a plurality of recording agents;
a usage environment input unit that inputs a usage environment of a printed matter;
a characteristics judgment unit that determines, based on the usage environment inputted at the usage environment input unit, the characteristics necessary for a desired recording agent;
an adaptation judgment unit that determines, based on the recording agent information of the recording agent information memory unit, among the plurality of recording agents, one recording agent that corresponds to the characteristics determined at the characteristics judgment unit; and
a recording agent selection unit that selects, among the plurality of recording agents, the one recording agent that is determined at the adaptation judgment unit.

17. A printing support program that supports using a recording agent to print, comprising:
a program that makes a computer execute a process including:
an inputting characteristics step for inputting characteristics of a desired recording agent;
a judging adaptation step for determining, based on recording agent information of a recording agent information memory unit that stores the recording agent information of the characteristics of a plurality of recording agents, among the plurality of recording agents, one recording agent that corresponds to the characteristics inputted at the inputting characteristics step; and
a presenting step for presenting the one recording agent determined at the judging adaptation step.

18. A printing support program that supports using a recording agent to print, comprising:
a program that makes a computer execute a process including:
an inputting usage environment step for inputting a usage environment of a printed matter;
a judging characteristics step for determining, based on the usage environment inputted at the inputting usage environment step, characteristics necessary for a desired recording agent;
a judging adaptation step for determining, based on recording agent information of a recording agent information memory unit that stores the recording agent information of the characteristics of a plurality of recording agents, among the plurality of recording agents, one recording agent that corresponds to the characteristics determined at the judging characteristics step; and
a presenting step for presenting the one recording agent determined at the judging adaptation step.

19. A printing support program that supports using a recording agent to print, comprising:
a program that makes a computer execute a process including:
an inputting characteristics step for inputting the characteristics of a desired recording agent;
a judging adaptation step for determining, based on recording agent information of a recording agent information memory unit that stores the recording agent information about characteristics of a plurality of recording agents, among the plurality of recording agents, one recording agent that corresponds to the characteristics inputted at the inputting characteristics step; and
a selecting step for selecting the one recording agent determined at the judging adaptation step among the plurality of recording agents.

20. A printing support program that supports using a recording agent to print, comprising:
a program that makes a computer execute a process including:
an inputting usage environment step for inputting a usage environment of a printed matter;
a judging characteristics step for determining, based on the usage environment inputted at the inputting usage environment step, the characteristics necessary for a desired recording agent;
a judging adaptation step for determining, based on recording agent information of a recording agent information memory unit that stores the recording agent information about characteristics of a plurality of recording agents, among the plurality of recording agents, one recording agent that corresponds to the characteristics determined at the judging characteristics step; and
a selecting step for selecting the one recording agent determined at the judging adaptation step among the plurality of recording agents.

21. A printing support method that supports using a recording agent to print, comprising:
inputting characteristics of a desired recording agent;
judging, based on recording agent information of a recording agent information memory unit that stores the recording agent information of the characteristics of a plurality of recording agents, among the plurality of recording agents, one recording agent that corresponds to the characteristics inputted at the inputting characteristics step; and
presenting the one recording agent judged at the judging step.

22. A printing support method that supports using a recording agent to print, comprising:
inputting a usage environment of a printed matter;
judging, based on the usage environment inputted at the inputting usage environment, characteristics necessary for a desired recording agent;
determining, based on recording agent information of a recording agent information memory unit that stores the recording agent information of the characteristics of a plurality of recording agents, among the plurality of recording agents, one recording agent that corresponds to the characteristics judged at the judging characteristics step; and
presenting the one recording agent determined at the determining step.

23. A printing support method that supports using a recording agent to print, comprising:
inputting characteristics of the recording agent;
judging, based on recording agent information of a recording agent information memory unit that stores the recording agent information of the characteristics of a plurality of recording agents, among the plurality of recording agents, one recording agent that corresponds to the characteristics inputted at the inputting characteristics step; and
selecting the one recording agent judged at the judging step among the plurality of recording agents.

24. A printing support method that supports using a recording agent to print, comprising:
inputting a usage environment of a printed matter;
judging, based on the usage environment inputted at the inputting usage environment, characteristics necessary for a desired recording agent;
determining, based on recording agent information of a recording agent information memory unit that stores the recording agent information of the characteristics of a plurality of recording agents, among the plurality of recording agents, one recording agent that corresponds to the characteristics judged at the judging characteristics step; and
selecting the one recording agent determined at the determining step among the plurality of recording agents.
